(19) United States
(12) Patent Application Publication
(10) Pub. No.: US 2005/0190072 A1
(43) Pub. Date: Sep. 1, 2005

(54) Item monitoring system and methods of using an item monitoring system

(76) Inventors: Katherine A. Brown, Lake Elmo, MN (US); Catherine H. Behun, White Bear Lake, MN (US); Kaileen Chen, White Bear Lake, MN (US); David P. Erickson, Stillwater, MN (US); Ronald D. Jesme, Plymouth, MN (US); Orlin B. Knudson, Vadnais Heights, MN (US); Robert D. Lorentz, North Oaks, MN (US); James P. McGee, Cedar, MN (US); Robert A. Sainati, Bloomington, MN (US); Lucien B. Solefack, Inver Grove Heights, MN (US); Justin Tungjunyatham, Falcon Heights, MN (US); Christopher R. Yungers, St. Paul, MN (US)

Correspondence Address: 3M INNOVATIVE PROPERTIES COMPANY, PO BOX 33427, ST. PAUL, MN, 55133-3427, US

(21) Appl. No.: 10/788,061

(22) Filed: Feb. 26, 2004

(51) Int. Cl. G08B 5/22

(52) U.S. Cl. 340/825.36

(57) ABSTRACT

An item monitoring system and method of using an item monitoring system. The present invention relates more particularly to an item monitoring system including a sensor, that senses a plurality of items in a first amount of space associated with the sensor and that senses both items containing metal and items containing no metal, a communications network, and a computer that receives information from the sensor through the communications network. The present invention also relates more particularly to a method of monitoring items to determine the number of items within a first amount of space associated with the sensor.

### TECHNICAL FIELD

The present invention relates to an item monitoring system and method of using an item monitoring system. The present invention relates more particularly to an item monitoring system including a sensor, that senses a plurality of items in a first amount of space associated with the sensor and that senses both items that contain metal and items that do not contain metal, a communications network, and a computer that receives information from the sensor through the communications network. The present invention also relates more particularly to a method of monitoring items to determine the number of items within a first amount of space associated with the sensor.

### BACKGROUND OF THE INVENTION

A variety of systems and methods are known for monitoring inventory or items on shelves or in supply areas, for example those disclosed in U.S. Pat. Nos. 5,671,362, 5,654,508, 6,085,589, 6,107,928, and 6,456,067, France Publication No. 2575053, Published Japanese Patent Application Nos. 10-243847 and 2000-48262. In addition, a variety of related sensing or detection devices are known, for example those disclosed in U.S. Pat. Nos. 4,293,852, 6,608,489, and 6,085,589.

### SUMMARY OF THE INVENTION

One aspect of the present invention provides an item monitoring system. The item monitoring system, comprises: a sensor, where the sensor senses a plurality of items in a first amount of space associated with the sensor, where the sensor is capable of sensing both items containing metal and items containing no metal; a communications network; and a computer, where the computer receives information from the sensor through the communications network.

In one preferred embodiment of the above item monitoring system, the sensor senses the plurality of items in the first amount of space and sends related information to the computer through the communications network. In another aspect of this embodiment, the computer determines the quantity of items within the first amount of space. In another aspect of this embodiment, the sensor senses the plurality of items in the first amount of space a first instance, the sensor senses the plurality of items in the first amount of space a second instance, and the computer compares the information from the first instance and the second instance to determine changes in the quantity of items within the first amount of space. In yet another aspect of this embodiment, the sensor determines the quantity of items within the first amount of space. In another aspect of this embodiment, the sensor senses the plurality of items in the first amount of space a first instance, the sensor senses the plurality of items in the first amount of space a second instance, and the sensor compares the information from the first instance and the second instance to determine changes in the quantity of items within the first amount of space.

In another preferred embodiment of the above item monitoring system, the item monitoring system further comprises a shelf, where the sensor is attached to the shelf. In another preferred embodiment of the above item monitoring system, the sensor is positioned such that the first amount of space is above the sensor. In another preferred embodiment of the above item monitoring system, the sensor is positioned such that the first amount of space is below the sensor. In another preferred embodiment of the above item monitoring system, the sensor is positioned such that the first amount of space is beside the sensor. In another preferred embodiment of the above item monitoring system, the response of the sensor is independent of the weight of the items in the first amount of space.

In another preferred embodiment of the above item monitoring system, the item monitoring system computer signals to a user whether the quantity of items in the first area of space is greater than or equal to a first quantity or below the first quantity. In another preferred embodiment of the above item monitoring system, the item monitoring system signals to a user whether the quantity of items in the first area of space is greater than or equal to a first quantity, less than the first quantity and greater than or equal to a second quantity, or is less than a second quantity. In another preferred embodiment of the above item monitoring system, the computer sends information to the sensor through the communications network. In another preferred embodiment of the above item monitoring system, the sensor comprises a planar capacitive sensor. In yet another aspect of this embodiment, the planar capacitive sensor responds to changes in the electric field configuration in the first amount of space and sends related information to the computer through the communications network, and the item monitoring system determines the quantity of items within the first amount of space. In yet another aspect of this embodiment, when items are removed from the first amount of space, the electric field configuration of the first amount of space changes and produces a frequency change in the planar capacitive sensor.

In yet another aspect of this embodiment, the sensor measures the frequency a first instance and sends related information to the computer through the communications network, the sensor measures the frequency a second instance and sends related information to the computer through the communications network, and the item monitoring system compares the frequency from the first instance and the second instance to determine changes in the quantity of items within the first amount of space. In yet another aspect of this embodiment, when items are removed from the first amount of space, the electric field configuration of the first amount of space changes and produces a phase change in the planar capacitive sensor. In yet another aspect of this embodiment, the sensor measures the phase a first instance and sends related information to the computer through the communications network, the sensor measures the phase a second instance and sends related information to the computer through the communications network, and the item monitoring system compares the phase from the first instance and the second instance to determine changes in the quantity of items within the first amount of space. In yet another aspect of this embodiment, the capacitive sensor includes electrodes attached to a non-metal substrate. In yet another aspect of this embodiment, the electrodes comprise a patterned layer of copper.

In another preferred embodiment of the above item monitoring system, the sensor comprises a waveguide. In another aspect of this embodiment, the sensor sends a signal through the waveguide, monitors the reflection of the signal, and sends related information to the computer through the communications network, and the item monitoring system determines the quantity of items within the first amount of space. In yet another aspect of this embodiment, the sensor sends a first signal through the waveguide a first instance and sends related information to the computer through the communications network, the sensor sends a second signal through the waveguide a second instance and sends related information to the computer through the communications network, and the item monitoring system compares the information from the first instance and the second instance to determine changes in the quantity of items within the first amount of space.

In another preferred embodiment of the above item monitoring system, the sensor comprises a photosensitive sensor. In another aspect of this embodiment, the photosensitive sensor responds to changes in the amount of light in the first amount of space and sends related information to the computer through the communications network, and the item monitoring system determines the quantity of items within the first amount of space. In another aspect of this embodiment, when items are removed from the first amount of space, the amount of light of the first amount of space increases and produces a current, voltage, or resistance change in the photosensitive sensor. In another aspect of this embodiment, the photosensitive sensor responds to the amount of light in the first amount of space a first instance and sends related information to the computer through the communications network, the photosensitive sensor responds to the amount of light in first amount of space a second instance and sends related information to the computer through the communications network, and the item monitoring system compares the information from the first instance and the second instance to determine changes in the quantity of items within the first amount of space. In yet another aspect of this embodiment, the photosensitive sensor is a photovoltaic sensor.

In another preferred embodiment of the above item monitoring system, a portion of the communication network is wireless. In another preferred embodiment of the above item monitoring system, the plurality of items within the first amount of space are all the same stock keeping unit. In another preferred embodiment of the above item monitoring system, the plurality of items within the first amount of space are a plurality of different stock keeping units. In another preferred embodiment of the above item monitoring system, the system includes a second sensor, the second sensor senses a plurality of items in a second amount of space associated with the second sensor. In another preferred embodiment of the above item monitoring system, the sensor generates a variable output that is related to the quantity of items in the first amount of space. In yet another aspect of this embodiment, the variable output may include frequency, phase, current, voltage, resistance, time, amplitude or combinations of such.

Another aspect of the present invention provides an alternative item monitoring system. This alternative item monitoring system comprises: a shelf; a planar capacitive sensor attached to the shelf, where the capacitive sensor responds to changes in the electric field configuration in a first amount of space above the planar capacitive sensor by producing a frequency change in the capacitive sensor, where the capacitive sensor includes electrodes attached to a non-metal substrate, where the electrodes comprise a patterned layer of copper, and where the planar capacitive sensor is capable of sensing both items containing metal and items containing no metal; a communications network, where a portion of the communication network is wireless; and a computer, where the computer receives information from the planar capacitive sensor through the communications network; where the planar capacitive sensor measures the frequency a first instance and sends related information to the computer through the communications network, where the planar capacitive sensor measures the frequency a second instance and sends related information to the computer through the communications network, where the computer compares the frequency from the first instance and the second instance to determine changes in the quantity of items within the first amount of space, and where the computer signals to a user whether the quantity of items in the first area of space is greater than or equal to a first quantity or below the first quantity.

Another aspect of the present invention provides an alternative item monitoring system. This alternative item monitoring system comprises: a shelf; a planar capacitive sensor attached to the shelf, where the capacitive sensor responds to changes in the electric field configuration in a first amount of space above the planar capacitive sensor by producing a phase change in the capacitive sensor, where the capacitive sensor includes electrodes attached to a non-metal substrate, where the electrodes comprise a patterned layer of copper, and where the planar capacitive sensor is capable of sensing both items containing metal and items containing no metal; a communications network, where a portion of the communication network is wireless; and a computer, where the computer receives information from the planar capacitive sensor through the communications network; where the planar capacitive sensor measures the phase a first instance and sends related information to the computer through the communications network, where the planar capacitive sensor measures the phase second instance and sends related information to the computer through the communications network, where the computer compares the phase from the first instance and the second instance to determine changes in the quantity of items within the first amount of space, and where the computer signals to a user whether the quantity of items in the first area of space is greater than or equal to a first quantity or below the first quantity.

Yet another aspect of the present invention provides an alternative item monitoring system. This alternative item monitoring system comprises: a shelf; a sensor attached to the shelf, where the sensor comprises a waveguide, and where the sensor is capable of sensing both items containing metal and items containing no metal; a communications network, where a portion of the communication network is wireless; and a computer, where the computer receives information from the sensor through the communications network; where the sensor sends a first electromagnetic wave signal through the waveguide a first instance, monitors the reflection of the first electromagnetic wave signal, and sends related information to the computer through the communications network, where the sensor sends a second electromagnetic wave signal through the waveguide a second instance, monitors the reflection of the second electromagnetic wave signal, and sends related information to the computer through the communications network, where the computer compares the information from the first instance and the second instance to determine changes in the quantity of items within the first amount of space and where the computer signals to a user whether the quantity of items in the first area of space is greater than or equal to a first quantity or below the first quantity.

Another aspect of the present invention provides an alternative item monitoring system. This alternative item monitoring system comprises: a shelf; a photovoltaic sensor attached to the shelf, where the photovoltaic sensor responds to changes in the amount of light in a first amount of space above the photovoltaic sensor, and where the photovoltaic sensor is capable of sensing both items containing metal and items containing no metal; a communications network, where a portion of the communication network is wireless; and a computer, where the computer receives information from the photovoltaic sensor through the communications network; where the photovoltaic sensor responds to the amount of light in the first amount of space a first instance and sends related information to the computer through the communications network, where the photovoltaic sensor responds to the amount of light in first amount of space a second instance and sends related information to the computer through the communications network, where the computer compares the information from the first instance and the second instance to determine changes in the quantity of items within the first amount of space, and where the computer signals to a user whether the quantity of items in the first area of space is greater than or equal to a first quantity or below the first quantity.

Another aspect of the present invention provides a method of monitoring items. The method of monitoring items comprises the steps of: providing a sensor, where the sensor senses a plurality of items in a first amount of space associated with the sensor, where the sensor is capable of sensing both items containing metal and items containing no metal; placing a plurality of items in the first amount of space; sensing the plurality of items in the first amount of space a first instance with the sensor; and determining the quantity of items within the first amount of space.

In one preferred embodiment of the above method, the method further comprises the steps of: providing a surface, a communications network, and a computer, where the sensor is attached to the surface, and where the computer receives information from the sensor through the communications network; after the sensing step, sending information related to the sensing step to the computer through the communications network; and determining the quantity of items within the first amount of space with the computer. In another preferred embodiment of the above method, the method further comprises the steps of: sensing the plurality of items in the first amount of space a second instance and sending related information to the computer through the communications network; and where the determining step includes comparing the information from the first instance and the second instance to determine changes in the quantity of items within the first amount of space. In another aspect of this embodiment, during the sensing step during the first instance, the first amount of space is full of items, and where before the sensing step during the second instance, one of the items is removed from the first amount of space, and where the method further comprises the step of calibrating the sensor based on the information from the sensing step during the first instance and the sensing step during the second instance. In another aspect of this embodiment, during the first instance, the first amount of space is full of items, and where before the sensing step during the second instance, all of the items are removed from the first amount of space, and where the method further includes the step of calibrating the sensor by interpolating the information from the sensing step during the first instance and the sensing step during the second instance to determine various states of fullness of items in the first amount of space.

In another preferred embodiment of the above method, the sensor is independent of the weight of the items in the first amount of space. In another aspect of this embodiment, after the determining step, the computer signals to a user whether the quantity of items in the first area of space is greater than a first quantity or below the first quantity. In another aspect of this embodiment, after the determining step, the computer signals to a user whether the quantity of items in the first area of space is greater than a first quantity, less than the first quantity and greater than a second quantity, or is less than a second quantity.

In another preferred embodiment of the above method, the sensor is a planar capacitive sensor. In another aspect of this embodiment, the sensing step includes responding to changes in the electric field configuration in the first amount of space and producing a frequency change in the planar capacitive sensor. In another aspect of this embodiment, the method further comprises the steps of: sensing the plurality of items in the first amount of space a second instance; and the determining step includes comparing the frequency measurements from the first instance and the second instance to determine changes in the quantity of items within the first amount of space. In another aspect of this embodiment, the sensing step includes responding to changes in the electric field configuration in the first amount of space and producing a phase change in the planar capacitive sensor. In another aspect of this embodiment, the method further comprises the step of: sensing the plurality of items in the first amount of space a second instance; and the determining step includes comparing the phase measurements from the first instance and the second instance to determine changes in the quantity of items within the first amount of space.

In yet another preferred embodiment of the above method, the sensor comprises a waveguide. In another aspect of this embodiment, the sensing step includes sending a first signal through the waveguide. In another aspect of this embodiment, the method further comprises the step of: sensing the plurality of items in the first amount of space a second instance by sending a second signal through the waveguide; where the determining step includes comparing the signal measurements from the first instance and the second instance to determine changes in the quantity of items within the first amount of space.

In another preferred embodiment of the above method, the sensor comprises a photosensitive sensor. In another aspect of this embodiment, the sensing step includes the photosensitive sensor responding to changes in the amount of light in the first amount of space. In another aspect of this embodiment, after the placing step, removing one of the plurality of times from the first amount of space, and where the sensing step includes producing a current, voltage or resistance change in the photosensitive sensor. In another aspect of this embodiment, the method further comprises the step of: sensing the plurality of items in the first amount of space a second instance by the photosensitive sensor responding to the amount of light in the first amount of space a second instance; and the determining step includes comparing the light measurements from the first instance and the second instance to determine changes in the quantity of items within the first amount of space. In another aspect of this embodiment, the sensor is a photovoltaic sensor.

In yet another preferred embodiment of the above method, the plurality of items within the first amount of space are all the same stock keeping unit. In yet another preferred embodiment of the above method, the plurality of items within the first amount of space are a plurality of different stock keeping units.

Another aspect of the present invention provides a capacitive sensor for monitoring items. The capacitive sensor for monitoring items comprises: a planar capacitive sensor that senses a plurality of items in a first amount of space associated with the planar capacitive sensor, where the capacitive sensor responds to changes in the electric field configuration in the first amount of space associated the planar capacitive sensor by producing a frequency change in the capacitive sensor to determine the quantity of items in the first amount of space, and where the planar capacitive sensor is capable of sensing both items containing metal and items containing no metal.

In one preferred embodiment of the above capacitive sensor, the planar capacitive sensor measures the frequency a first instance, the planar capacitive sensor measures the frequency a second instance, and the planar capacitive sensor compares the frequency from the first instance and the second instance to determine changes in the quantity of items within the first amount of space. In another preferred embodiment of the above capacitive sensor, the planar capacitive sensor is connected to a computer, and where the planar capacitive sensor measures the frequency a first instance and sends related information to the computer, where the planar capacitive sensor measures the frequency a second instance and sends related information to the computer, and where the computer compares the frequency from the first instance and the second instance to determine changes in the quantity of items within the first amount of space. In one aspect of this embodiment, the computer signals to a user whether the quantity of items in the first area of space is greater than or equal to a first quantity or below the first quantity. In another aspect of this embodiment, the capacitive sensor includes electrodes attached to a non-metal substrate, where the electrodes comprise a patterned layer of copper.

Another aspect of the present invention provides a capacitive sensor for monitoring items. The capacitive sensor for monitoring items comprises: a planar capacitive sensor that senses a plurality of items in a first amount of space associated with the planar capacitive sensor, where the capacitive sensor responds to changes in the electric field configuration in the first amount of space by producing a phase change in the capacitive sensor to determine the quantity of items in the first amount of space, where the planar capacitive sensor is capable of sensing both items containing metal and items containing no metal. In one preferred embodiment of the above capacitive sensor, the planar capacitive sensor measures the phase a first instance, where the planar capacitive sensor measures the phase second instance, where the planar capacitive sensor compares the phase from the first instance and the second instance to determine changes in the quantity of items within the first amount of space. In one aspect of this embodiment, the planar capacitive sensor is connected to a computer, where the planar capacitive sensor measures the phase a first instance and sends related information to the computer, where the planar capacitive sensor measures the phase a second instance and sends related information to the computer, and where the computer compares the phase from the first instance and the second instance to determine changes in the quantity of items within the first amount of space. In another aspect of this embodiment, the computer signals to a user whether the quantity of items in the first area of space is greater than or equal to a first quantity or below the first quantity. In another preferred embodiment of the above capacitive sensor, the capacitive sensor includes electrodes attached to a non-metal substrate, where the electrodes comprise a patterned layer of copper.

Another aspect of the present invention provides a waveguide sensor for monitoring items. The waveguide sensor for monitoring items comprises: a waveguide sensor including a waveguide that senses a plurality of items in a first amount of space associated with the waveguide sensor, where the waveguide sensor sends a signal through the waveguide and monitors the signal's reflection to determine the quantity of items in the first amount of space, where the sensor is capable of sensing both items containing metal and items containing no metal. In another preferred embodiment of the above waveguide sensor, the waveguide sensor sends a first signal through the waveguide a first instance and monitors the reflection of the first signal, where the waveguide sensor sends a second signal through the waveguide a second instance and monitors the reflection of the second signal, where the waveguide sensor compares the reflection of the first signal from the first instance and the reflection of the second signal the second instance to determine changes in the quantity of items within the first amount of space. In one aspect of this embodiment, the waveguide sensor is connected to a computer, where the waveguide sensor sends a first signal through the waveguide a first instance, monitors the reflection of the first electromagnetic wave signal, and sends related information to the computer, where the waveguide sensor sends a second signal through the waveguide a second instance, monitors the reflection of the second signal, and sends related information to the computer, where the computer compares the information from the first instance and the second instance to determine changes in the quantity of items within the first amount of space. In one aspect of this embodiment, the computer signals to a user whether the quantity of items in the first area of space is greater than or equal to a first quantity or below the first quantity.

Another aspect of the present invention provides a photosensitive sensor for monitoring items. The photosensitive sensor for monitoring items comprises: a photosensitive sensor that senses a plurality of items in a first amount of space associated with the photosensitive sensor, where the photosensitive sensor responds to changes in the amount of light in a first amount of space, and where the photosensitive sensor is capable of sensing both items containing metal and items containing no metal. In one aspect of this embodiment, the photosensitive sensor responds to the amount of light in the first amount of space a first instance, where the photosensitive sensor responds to the amount of light in first amount of space a second instance, where the photosensitive sensor compares the information from the first instance and the second instance to determine changes in the quantity of items within the first amount of space. In another aspect of this embodiment, the photosensitive sensor is connected to a computer, where the photosensitive sensor responds to the amount of light in the first amount of space a first instance and sends related information to the computer, where the photosensitive sensor responds to the amount of light in first amount of space a second instance and sends related information to the computer, where the computer compares the information from the first instance and the second instance to determine changes in the quantity of items within the first amount of space. In yet another aspect of this embodiment, the computer signals to a user whether the quantity of items in the first area of space is greater than or equal to a first quantity or below the first quantity.

### BRIEF DESCRIPTION OF THE DRAWINGS

The present invention will be further explained with reference to the appended Figures, wherein like structure is referred to by like numerals throughout the several views, and wherein:

FIG. 1 illustrates a schematic view of one embodiment of an item monitoring system of the present invention;

FIG. 2 illustrates an electrical block diagram of one embodiment of a sensing device;

FIG. 3 illustrates a perspective view of the shelf arrangement of FIG. 1 with the items removed from the shelves;

FIG. 3a is a cross sectional view of a portion of one of the sensors of FIG. 3 taken along line 3a-3a;

FIG. 3b is a cross sectional view of one of the sensors of FIG. 3 taken along line 3b-3b;

FIG. 4a illustrates a top view of one of the shelves with items of FIG. 1 taken along line 4a-4a;

FIG. 4b illustrates a top view like FIG. 4a with some items removed from the shelf;

FIG. 5a illustrates a top view of one of the shelves with items of FIG. 1 taken along line 5a-5a; and

FIG. 5b illustrates a top view like FIG. 5a with some items removed from the shelf.

### DETAILED DESCRIPTION OF THE INVENTION

Out-of-stock items on store shelves are a significant problem for retail stores and wholesale stores. If a customer is looking for a particular product on a shelf or in a display area and that particular product is out of stock, the retailer or wholesaler lost the opportunity to sell that product to the customer, ultimately resulting in lost sales. In fact, if the customer needs the product immediately, it's possible that he or she may leave the store and go to a competitive store to purchase the product, ultimately resulting in lost customers for that store that didn't have the product in stock. According to some industry studies, items that are frequently out of stock in retail stores include hair care products, laundry products, such as laundry detergent, disposable personal care items, particularly disposable diapers and feminine hygiene products, and salty snacks.

A typical retail store or wholesale store may have employees visually inspect the shelves or product display areas to assess what products need to be restocked, or reordered. Alternatively, such stores may have certain times of the week designated for when areas of the store will be restocked with products. However, due to the hundreds, thousands or even tens of thousands of different items in large retail establishments, manual methods of determining inventory are generally too slow to provide useful real-time information. In addition, manual methods are quite labor intensive and are often prone to error.

One example of a prior art device that assists in determining whether items are present on a shelf is a shelf mounted on a set of specialized mounting brackets including load cells. These specialized mounting brackets will assist in detecting the total, combined weight of all of the items placed on the shelf, but they may not be able to provide useful information about each type of item on the shelf. For example, if the capacity of a shelf is forty containers of a certain size and the retailer stocked this shelf with four different types of items in relatively same sized containers, for example, ten individual units of each of four different types of laundry detergent products, then the retailer would only be able to determine information about the combined inventory of laundry detergent products using this device. In other words, the retailer would not know whether “50% of the full weight” meant that two of the detergent types were completely gone and, thus in need of restocking, or if each of the detergent types still had five containers left on the shelf, or some other combination. Generally, the retailer is most interested in learning about which type of laundry detergent goes out of stock first, because that is the type which is apparently selling best, and the retailer will want to be sure to keep his shelves fully stocked with that particular type.

Therefore, retailers and wholesalers would benefit from having an automated system for monitoring items on their store shelves, particularly for the purpose of knowing when re-stocking of the shelf or display area is needed, and even more particularly for the purpose of knowing when re-stocking of a particular type of item is needed. An item monitoring system of the present invention provides such an automated system to retailers and wholesalers with at least the following benefits.

First, the item monitoring system of the present invention provides information that is current, nearly current, or recently up to date, otherwise known as real-time information. In contrast, prior art systems that collect data over a long period of time, process the data, and then provide information to the retailer, will not allow the retailer to correct out-of-stocks promptly, resulting in lost sales. Moreover, the item monitoring system can provide quantitative information related to inventory levels of products on product displays or shelves and signal to a user when a particular product is starting to run low, well before the product is gone entirely from the display or shelf, allowing the retailer time to restock that product, avoiding lost sales. In contrast, some prior art systems only indicate when the shelves are empty, which does not provide a retailer with information about shelf stock levels or prompt the retailer to restock the shelf with product before the product goes out of stock.

Second, the item monitoring system of the present invention provides information about the products in the store, and in particular, provides information specific to each group of identical products or individual stock keeping units (“SKUs”), as they are commonly known in the industry. SKUs are commonly used to identify all the products offered in the store, depending on their brand, type, size, and other factors. Each unique type of product is generally assigned a unique alphanumeric identifier (an SKU). For example, one SKU designates Brand X Shampoo for Normal Hair, 15-ounce size. Another SKU designates Brand X Shampoo for Normal Hair, 20-ounce size. Another SKU designates Brand X Shampoo for Dry Hair, 15-ounce size. Another SKU designates Brand Y Shampoo for Normal Hair, 15-ounce size, and so on. This example helps illustrate that each shampoo type will have a different SKU, even if the shampoos are the same brand, for example, because they may differ in intended uses (“dry hair” versus “normal hair”) or differ in size (15 ounces versus 20 ounces). Frequently, a large retail establishment may utilize as many as 50,000 different SKUs to account for all the unique items in the store. That is, each product within a SKU is identical with respect to brand, size, color, shape, and other features such as flavor, fragrance, and intended use, for example, but the products with the same SKU may have variations in manufacturing date, shipping date, minor lot-to-lot color variation, and so on. Product displays or shelves in stores may include only one item, particularly for large in size or expensive SKUs, such as, for example, a bicycle. However, in general, for most consumer items, there will be a plurality of individual items displayed within each SKU and often a plurality of SKUs in a fully stocked display or shelf. The item monitoring system of the present invention provides quantitative information about how many items are on the shelf for each SKU, in contrast to prior art systems that do not provide information to such a detailed extent.

Third, the item monitoring system of the present invention does not require any changes to the consumer items or their associated packaging. The item monitoring system of this invention will detect items that are no different from items, that are found in nearly every retail store today, as will be apparent from the Examples.). In contrast, prior art systems have required the use of specialized devices attached to each product to track the movement of the products off the shelves, such as item-level labels, tags, antennae, or inserts or packaging materials employing materials or devices including, but not limited to, integrated circuits, magnetic materials, metallic materials or metal-containing parts, reflective parts, specialized inks, specialized films and the like. These prior art devices are typically undesirable because they often require significant and expensive changes for the product manufacturer, distributor or retailer to incorporate such devices into each and every product for the store.

Fourth, the item monitoring system of the present invention has low power requirements, so that power lines will not need to be installed to supply power to each shelf and associated system hardware. Preferably, almost all of the power requirements at display shelves may be met with small batteries that only need to be changed infrequently, for example, about one time per year.

Finally, since many retailers, such as grocers and discount stores, operate with small profit margins, the complexity and the number of components or parts of the item monitoring system is minimized to reduce system cost. Further, installation and operating costs of the item monitoring system are minimal to provide the lowest possible overall costs for the system to the storeowner, manager or operator.

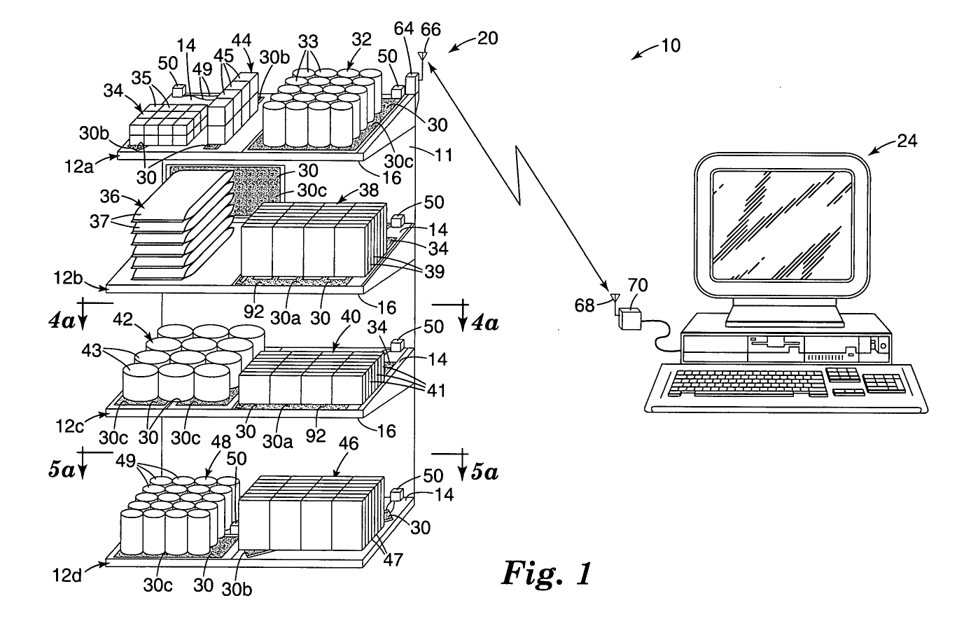

FIG. 1 illustrates one preferred embodiment of the item monitoring system 10 of the present invention. The item monitoring system 10 is designed to provide information to a user concerning the number or quantity of items in a designated area or space, such as the space allotted to a group of like items, that is a group of items with the same SKU, on a portion of a shelf. The item monitoring system 10 includes at least one sensor 30, a communications network, and a computer 24. For the item monitoring system 10, there are a variety of suitable sensors 30, which are discussed in more detail below.

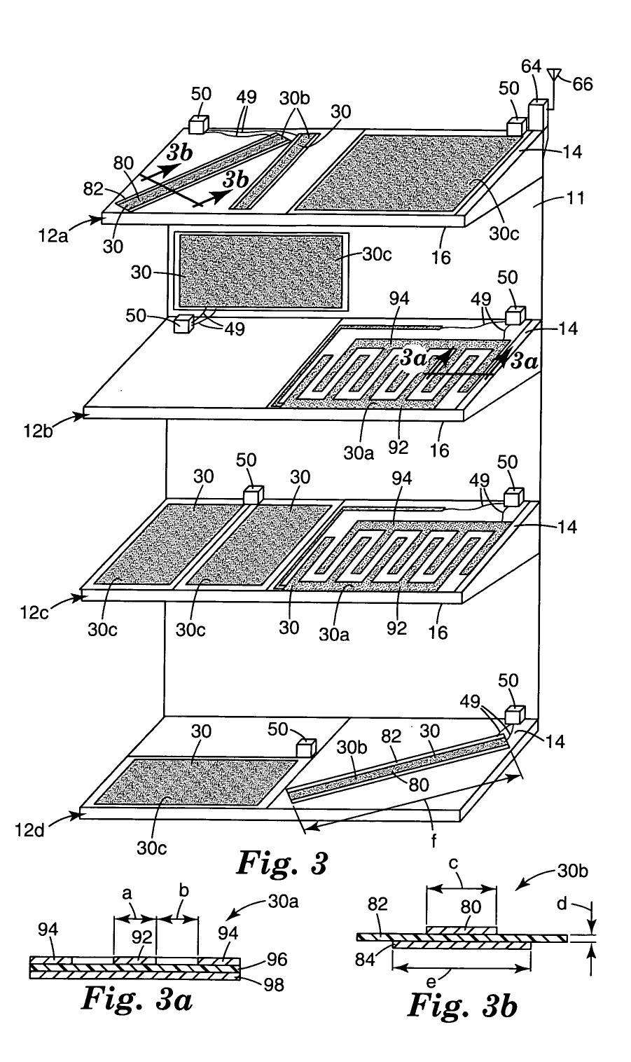

The item monitoring system 10 preferably includes a shelf arrangement 20, which includes a plurality of shelves 12. The shelf arrangement 20 illustrated in FIG. 1 and FIG. 3 includes a first shelf 12a, a second shelf 12b, a third shelf 12c, and a fourth shelf 12d. The shelves 12a-12d are all illustrated as mounted to a back panel 11. However, shelves 12a-12d may be just as easily mounted to a wall. Shelf arrangements 20 are commonly found in retail stores and other establishments. Therefore, it is possible to use existing shelving in stores to help minimize installation costs.

Each shelf 12a-12d in the shelf arrangement 20 includes at least one sensor 30 attached to it. The term “attached” and its variants as used herein, including in the claims, means that the sensor 30 may be built into or is part of the shelf 12 itself, or it may be attached to either the top surface 14 or bottom surface 16 of the shelf 12, or it may be attached to a wall or panel 11 adjacent the items 12, physically integrated within an item display structure or set on top of a shelf. Attachment may be accomplished by mechanical means, such as mechanical fasteners, magnetic strips or the use of adhesives or a combination of these. Useful adhesives may be permanent or temporary, may include pressure sensitive adhesives, and may have additional features such as repositionability or clean removal.

The sensor 30 is preferably attached to a surface, such as the top surface 14 of a shelf 12, the bottom surface 16 of a shelf 12, or on a wall or panel 11 adjacent a shelf 12. Items are arranged on the shelves 12a-12b similar to how products typically arranged on a shelf in a retail or wholesale store today, with like items all grouped together. Each item within a group has the same stock keeping unit or SKU, as explained in more detail above. Each group of items is positioned such that it is adjacent at least one sensor 30. For example, items 33 of a first SKU are positioned in group 32 in a first amount of space adjacent sensor 30c on the first shelf 12a. Items 45 of a second SKU are positioned in group 44 in a second amount of space adjacent sensor 30b on first shelf 12a. Items 35 of a third SKU are positioned in group 34 in a third amount of space adjacent sensor 30b on first shelf 12a. Items 37 of a fourth SKU are positioned in group 36 in a fourth amount of space adjacent the sensor 30c mounted on the back panel 11 adjacent the second shelf 12b. Items 39 of a fifth SKU are positioned in group 38 in a fifth amount of space adjacent sensor 30a on the second shelf 12b. Items 41 of a sixth SKU are positioned in group 40 in a sixth amount of space adjacent sensor 30a on the third shelf 12c. Items 43 of a seventh SKU are positioned in group 42 in a seventh amount of space adjacent two sensors 30c on the third shelf 12c. Items 47 of an eighth SKU are positioned in group 46 in an eighth amount of space adjacent sensor 30b on the fourth shelf 12d. Items 49 of a ninth SKU are positioned in group 48 in a ninth amount of space adjacent sensor 30c on the fourth shelf 12d. Although one preferred embodiment is illustrated in FIG. 1, shelf arrangement 20 may include any number of shelves 12, and any number of sensors 30 to monitor any number of various SKUs, so long as each sensor 30 may detect a multiplicity of items.

Although the item monitoring system 10 is illustrated as including a shelf arrangement 20, the system may include sensors 30 mounted to almost any surface that is not part of a shelf arrangement, such as the bottom or any side of a basket or bin, a countertop, a surface on the outside or inside of a case or cabinet, the top of a stand or table, or other surfaces that may be used to display or store items, so long as the items to be detected are placed within the sensing space associated with the sensor. Alternatively, the sensors 30 may also be mounted on suitable brackets, frames or other devices to secure the sensor 30 to a boundary of an area or amount of space containing items, where such area of space does not include a wall or other surface.

Some bulky consumer items may be packaged in packaging materials that are not rigid. One example is 50-pound bags of dog food, and another example is 40-pound bags of salt for water softeners. Such items are typically stacked on a shelf, as is shown in FIG. 1 for items 37 in group 36. For such items, it may be preferable to place sensors 30 on a back wall or panel 11.

Each sensor is designed to monitor a plurality of items within a designated area or amount of space. The phrase “amount of space” as used herein, including the claims, refers to the three-dimensional space or area where an item may be positioned within and the sensor 30 may detect its presence. For example, the sensor 30a on second shelf 12b monitors items 39 which are in the space directly above the sensor 30a. As another example, sensor 30c mounted on back panel 11 perpendicular to second shelf 12b monitors the space where items 37 are stacked in group 36. Because the item monitoring system 10 may use a single sensor 30 to detect multiple items, the number of sensors to be installed is minimized, thereby helping to minimize installation costs.

It is not necessary that the items in the designated space be in contact with the sensor 30, and it is not necessary that the sensor physically support the items in the designated space. Instead, it is only necessary that when the items are positioned somewhere within the amount of space designated to that sensor, the sensor responds to the presence of items. The sensors 30 of the present invention are different from the prior art weight sensors discussed above, where the items to be monitored are required to be supported by the sensors and where their weight (that is, their mass times the force of gravity) is detected by the sensor. Therefore, the sensors 30 of item monitoring system 10 offer at least two advantages. One advantage is that the sensors 30 can be mounted at any location associated with the group of items, such as mounted behind, mounted in front of, mounted above, or mounted below the items to be sensed or detected. This arrangement provides flexibility in installation and the possibility of installation in unobtrusive locations, such as the underside of a shelf or the back panel of a shelving unit. Another advantage is that the sensors 30 of the present invention are less prone to mechanical failure or fatigue, in comparison to the prior art weight sensors. The prior art weight sensors are more subject to mechanical failure or fatigue because they have moving parts or parts that are subject to repeated deflection (such as springs) and load-bearing parts which can deform with time, heavy loads, or rough use.

The sensors 30 may be any size. For example, the sensors 30 may be about the same dimensions as the “footprint” of the group of items above, below, or beside them, or the sensor 30 may be smaller than the footprint of the items above, below, or beside them. The sensors 30 may monitor the space related to the entire surface of the shelf 12, or may only monitor the space relating to a portion of the shelf 12. For example, the sensors 30 may only occupy the space along the front edge of the shelf 12 space closest to the customer. This arrangement is useful for notifying the store when the front of the shelf is empty of product. When the front edge of a shelf is empty, a retailer may wish to restock the shelf, or move the remaining inventory in that SKU forward to the front of the shelf, or both. To make a portion of the sensors 30 visible, the item monitoring system 10 in FIG. 1 is illustrated such that the items on the shelves 12 do not entirely cover the sensors 30 and as a result, some space is visible between the groupings of SKUs, however, the sensors 30 may be completely covered by items of the same SKU, when the shelf is completely stocked, and there need not be spaces between adjacent groupings of SKUs.

The sensors 30 should be able to detect, that is, provide a response to, a large variety of physical items with a wide range of physical characteristics, such as size, shape, density, and electrical properties. These items, which are typically products and their associated packaging materials, are made from a wide variety of materials including, but not limited to, the following: organic materials, such as foodstuffs, paper, plastics, chemicals; chemical mixtures, such as detergents; cosmetic items; inks and colorants; inorganic materials, such as water, glass, metal in the form of sheets, cans, foils, thin layers and devices, electronic components, and pigments; and combinations of these. This list of materials is not meant to be all-inclusive, but is given to illustrate that the variety of materials in such items is quite large. In particular, it should be noted that the inventory in most all retail stores includes some products and their affiliated packaging that contain metal and some products and their affiliated packaging that do not contain metal but contain other materials, such as plastic, etc. Therefore, the item monitoring system 10 is able to detect items containing metal, as well as items that do not contain metal. For example, some industry studies indicate that frequent out-of-stock items in retail stores include hair care products. Hair care products include items such as plastic shampoo bottles, which typically do not contain metal, and aerosol cans of hair spray, which typically do contain metal. Prior art sensing devices for monitoring inventory typically are unable to monitor both items containing metal and items that do not contain metal.

The item monitoring system 10 may include a variety of different sensors 30. One preferred sensor 30 is a planar capacitor sensor 30a. Another preferred sensor 30 is a sensor 30b that includes a waveguide. Another preferred sensor 30 is a photosensitive sensor 30c that detects light from lighting sources, including ambient light. Each of these preferred sensors 30a-30c provide a response that is related to the number of items in the space associated with the sensor. Each of these preferred sensors 30a-30c are described in more detail below. However, the present invention is not limited to these preferred sensors 30a-30c. The present invention may include any sensor known in the art that can sense a plurality of items in the space associated with the sensor.

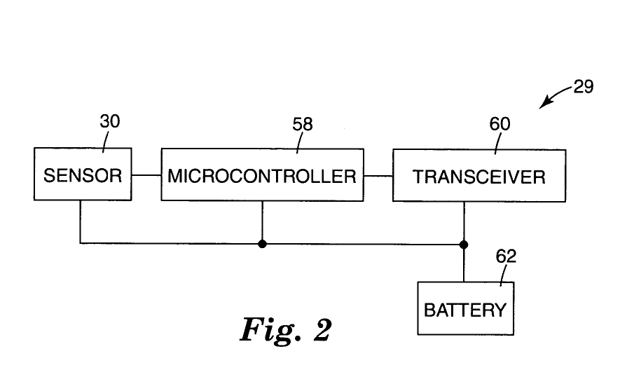

The item monitoring system 10 shown in FIG. 1 includes sensor electronics 50. The combination of a sensor 30 and sensor electronics 50 is referred to as a sensing device. The block diagram in FIG. 2 depicts a sensing device 29 that includes a sensor 30, and sensor electronics including a microcontroller 58, transceiver 60 and an optional battery 62. Optionally, sensor electronics 50 includes an antenna (not shown) that is electrically connected to transceiver 60.

The item monitoring system 10 shown in FIG. 1 includes a computer 24. Optionally, the item monitoring system 10 includes one or more nodes 64 and a transceiver 70. The system components that provide communication, including transceiver 60 in the sensor electronics 50, node 64, and transceiver 70, are together referred to as a communication network. Alternatively, the communications network may be any means known in the art for transferring information between the sensor 30 and computer 24.

The sensor 30, with the assistance of its associated sensor electronics 50, provides information to the computer 24 though the communications network. Preferably, this information is sent at time intervals such that the inventory information per SKU space or monitored space of the item monitoring system 10 is current or recently up to date regarding what items are on the shelves in the store.

The communication network preferably includes a node 64, which optionally includes an antenna 66. Preferably, node 64 is within the transmission range of the sensor electronics 50 associated with the sensors 30 and receives information from the sensor electronics 50. Generally, one or more nodes 64 are used to relay information from sensor electronics 50 to transceiver 70, particularly when the distance between sensor electronics 50 and transceiver 70 is greater than the transmission range of the transceiver 60 in the sensor electronics 50. Such information may be digital or analog data. Alternatively, node 64 may receive information from other sources and transmit that information to sensors 30 through sensor electronics 50. Node 64 may also process the data from sensor electronics 50. Examples of such processing include, but are not limited to, calculations or comparisons to interpret, simplify or condense the output of the sensor electronics 50. Optionally, node 64 may also store data sent by sensor electronics 50 for a period of time, or it may also store other data such as the time associated with a transmission from sensor electronics 50. The communications network may include any number of nodes to help transfer data from a large number of shelf arrangements 20, each shelf system having a plurality of sensors 30. One example of a suitable node 64 is commercially available from Microhard Systems, Inc., located in Calgary, AB, Canada as part number MHX-910.

Transceiver 70 and/or computer 24 may also be connected to other devices that interface with store personnel, customers, suppliers, shipping or delivery personnel and so on, or to other devices or equipment that interface with computers, servers, databases, networks, telecommunication systems and the like.

Signals, commands and the like may be transmitted through the communications network via wires or cables, or they may be transmitted wirelessly, or it may be partly wired and partly wireless. At least a partly wireless communication network is preferred and completely wireless communications are more preferred for a variety of reasons. First, it helps to avoid the unsightly appearance of cables and wires running throughout the store. Second, wireless communication networks may be less expensive and easier to install. One example of wireless transmission is accomplished by the use of frequencies available in the United States Federal Communication Commission Industrial-Scientific-Medical (“ISM”) band, preferably in one of the ranges 300 to 450 MHz, 902-928 MHz and 2.45 GHz. Examples of standardized communication protocols useful for the communication network include: the 802.11 standards set by the Institute of Electrical and Electronics Engineers, Inc. located in Piscataway, N.J.; the Bluetooth standard, which was developed by an industrial consortium known at the BLUETOOTH SIG, located in Overland, Park, Kans.; and or proprietary ISM band communication network Those skilled in the art recognize that different frequency ranges may be utilized as appropriate. A proprietary (non-standardized) communication protocol may be preferred for transmission to and from sensor electronics 50.

Components of the communication network may be installed by attaching them to existing structures in a store, such as shelves, walls, ceilings, stands, cases and the like. In general, they will be installed at a spacing distance that will enable communication with every location in the store. However, it is within the scope of this invention to monitor only a portion of a store with the item monitoring system of this invention.

The item monitoring system 10 includes a computer 24. Computers 24 are well understood in the art. A variety of different software programs known in the art may be used to collect the information sent by the sensor 30 and sensor electronics 50 though the communications network. One example of suitable software for use on computer 24 is software commercially available under the tradename LabVIEW from National Instruments based in Austin, Tex. This software is useful for creating views on the computer that display the current SKUs in stock on the shelf arrangements 20. Another example of suitable software is MICROSOFT brand software SQL Server from Microsoft Corporation located in Redmond, Wash. Alternatively, customized software may be preferred. Commercial or customized software is used to process, organize and present the information from the sensing devices in a user-friendly format. For example, the software may be designed so that the quantity of each group of SKUs is presented on a map of the store, showing the status of particular SKUs in particular locations. These displays may be customized to present data to and interact with different users who may have different needs or interest, for example, retailers and manufacturers. Many different information presentation formats will be apparent to those skilled in the art. The software may allow the retailer or supplier to set thresholds below which “time to restock” warnings are issued with either a visual or audible signal. The software may also be configured for periodic data collection from the sensor 30 and sensing electronics 50, or to collect data from the sensor 30 and sensing electronics 50 only upon request, or some combination thereof. It is also within the scope of this invention to use additional data, such as point-of-sale data or historical data, in combination with data obtained from the sensors 30 and sensor electronics 50 to help improve the interpretation of the data gathered from the sensor 30 and sensing electronics 50, to help improve accuracy, to detect situations requiring additional attention or human intervention, and the like. Information from the item monitoring system of this invention may be useful to store personnel, (such as store owners, store managers, stock personnel and the like, distributors, delivery personnel, consumer goods manufacturers, such as manufacturing personnel, planners, marketing and sales personnel, and such information may be shared with these groups through such means as internet networks.

Each sensor 30 may have its own sensor electronics, or the sensing electronics 50 may be connected to more than one sensor 30. For example, sensor 30c on first shelf 12a has its own sensor electronics 50 (as illustrated more clearly in FIG. 3). Two sensors 30b on first shelf 12a share one sensor electronics 50. The sensor 30a on second shelf 12b and the sensor 30c mounted on the back panel 11 adjacent second shelf 12b each have their own sensor electronics 50. The two sensors 30c on third shelf 12c share one sensor electronics 50. The sensor 30a on third shelf 12c has its own sensor electronics 50. The sensor 30b and the sensor 30c on the fourth shelf 12d each have their own sensor electronics 50. Alternatively, the sensor electronics 50 may be hidden from a customer's view, such as mounted behind the panel 11. Each sensor electronics 50 is electrically connected to its associated sensor 30, for example, by wires 49 or physically attached to the sensor itself.

Preferably, sensor electronics 50 include at least a microcontroller and a transceiver, such as a radio frequency transceiver. However, sensor electronics 50 may include one or more components such as memory devices, a clock or timing devices, batteries, directional couplers, power splitters, frequency mixers, low pass filters, and the like. Other components may also be added to the sensor electronics 50 to form tank circuits, circuits for converting alternating to direct current, signal generators, phase detector circuits, and the like. The sensor electronics 50 may provide storage of a unique digital identifier for each sensor 30. The unique digital identifier is preferably a unique number, which is stored in a memory component, preferably a non-volatile memory component, such as an integrated circuit. This unique number may be associated with the SKU numbers in, for example, a database.

FIG. 2 illustrates a block diagram of one preferred sensing device 29. Each sensing device 29 includes a sensor 30 and associated sensing electronic 50. The sensor electronics includes a microcontroller 58 and a transceiver 60. The transceiver 60 is preferably a radio frequency transceiver. The sensor electronics may optionally include a battery 62. The sensing device 29 operation is controlled by the microcontroller 58 located in the sensor electronics 50. The radio frequency transceiver 60 is connected to the microcontroller 58 in the sensor electronics 50 and is used to communicate with the communications network, which may include the optional node 64, or optional transceiver 70, or communicate directly to the computer 24. (The node 64, transceiver 70 and computer 24 are all illustrated in FIG. 1). The optional battery 62 may power the sensor 30 and the sensor electronics 50.

In one embodiment, the sensor electronics assists in converting the sensor 30 output to digital data and transmitting the digital data through the communications network to the computer. Optionally, the sensor electronics may perform calculations, analyses or other processing of the sensor 30 output. Optionally, the sensor electronics may also receive digital information, for example, commands from the computer through the communications network. Optionally, the sensor electronics may also store sensor 30 output for a period of time, and it may also generate and store other data, such as the time associated with the sensor output. The sensor electronic may process the output of the sensor 30 in a variety of ways, including, but not limited to, steps such as analog to digital conversion, and calculations or comparisons to interpret, simplify or condense the sensor 30 output.

The sensors 30 set forth herein are advantageous in that they generate small amounts of data, thereby allowing for frequent sampling, and provide adequate quantitative information to the retailer. In addition, sensors 30 described herein provide outputs, such as variable value outputs (described in more detail below), that may require very little data processing.

It may be preferable to conserve energy by using a sequence of “awake” and “sleep” cycles in the sensing device 29. One example of such a method of operation of a sensing device 29 is as follows. To start, the sensing device 29 is in a low power “sleep” mode. Once every polling interval, the sensing device 29 “wakes up” from sleep mode (either by receiving a command from the computer through the communications network or at a set time or interval that is stored in the sensor electronics 50), and gathers data about the items in the space associated with the sensor 30. Optionally, the sensor electronics 50 may average or compare two or more sets of data. The data (raw or processed) is sent to the computer 24 through the communications network, which is described in more detail above. The sensing device 29 is then returned to the “sleep” mode. The polling interval for the sensing device 29 may be set through the software in the computer 24. The minimum polling time is determined by the time to process the response. One example of a suitable polling time or interval is every 5-10 minutes.

Preferably, sensors 30 and sensor electronics 50 have low power requirements, and may be powered either by battery, a wired power supply, or by photovoltaic devices that collect and convert ambient energy (such as light) to electricity to power sensors 30 and sensor electronics 50. Photovoltaic sensors 30c may be used both as a power source and as a sensor, that is, one photovoltaic component may be used for two purposes (sensing and power supply). Using such batteries or photovoltaic power sources also helps eliminate the disruption, expense and unsightliness of wires installed at each sensor 30. Maintenance, for example battery changes, is minimized when sensor 30 power requirements are low. In addition, minimizing data sampling, data transmission and data processing assists in keeping overall power demands at a minimum.

Examples of suitable sensor electronics components that are commercially available include the following: a microcontroller from Microchip, located in Chandler, Ariz., as part number 16LF88; a radio frequency transceiver from Honeywell Inc., located in Plymouth, Minn., as part number HRF-ROCO9325; and a battery from Panasonic Industrial Company, division of Matsushita Electric Corporation of America, located in Secaucus, N.J., as part number CR2032. Suitable circuits for sensor electronics may be found in a number of references, for example a suitable oscillator tank circuit may be found in A. S. Seddra and K. C. Smith Microelectronic Circuits, Fourth Edition, 1998 Oxford University Press, Oxford/New York, pp. 973-1031 which is hereby incorporated by reference. A suitable phase detector circuit may be found in Floyd M. Gardner, Ph.D., Phaselock Techniques, Second Edition, 1979, John Wiley & Sons, Inc., New York, N.Y., pp. 106-125, which is hereby incorporated by reference.

One of the advantages of the item monitoring system 10 is that it can provide information to the user (for example, the store owner, store manager or consumer goods manufacturer) about the number of products on the shelves in the store at the SKU level. This is accomplished by having at least one sensor 30 responsive to approximately the same three-dimensional space that is occupied by a plurality of items or products all having the same SKU and associating the information from the sensor 30 with that space. For the embodiment illustrated in FIG. 1, each sensor 30 is responsive to a group of items within the same SKU. The sensors may be periodically polled for measurements related to their respective SKU spaces. A certain number of items may be removed from the space associated with sensor 30 after a first measurement, but before a second measurement made by sensor 30. As a result, there will be a difference between the first measurement and the second measurement by the sensor, which correlates to a difference in the number of items in the sensor's associated space at the first time and the second time. For example, the sensor 30c on first shelf 12a will provide two different measurements before and after some items 33 are removed from the first shelf 12a. As another example, the sensor 30a on shelf 12b will provide two different measurements before and after some items 39 are removed from the second shelf 12b. As another example, the sensor 30b on shelf 12d will provide two different measurements before and after some items 47 are removed from the fourth shelf 12d, and so on. The magnitude of the difference between two measurements relating to different numbers of items in the space associated with a sensor depends on the type of sensor, the sensor design, the type of items in the space, and other factors such as interference or noise. Examples 1-5 provide specific data for the results obtained with different sensors and items. Each sensor 30 is optionally calibrated relative to the items within the same SKU, so that the item monitoring system 10 can determine more precisely how many items have been taken from the sensor space. (The calibration process is described in more detail below.) Each sensor 30 is arranged to monitor items with the same SKU, so that they can provide information for each SKU stocked in the store, and as a result, a user can determine which SKU items need to be restocked. Multiple items sensed or detected by one sensor is also advantageous because it helps to minimize the cost and labor of fabrication and installation. It is easier to install one sensor 30 than to install multiple sensors to monitor one SKU space. Further, each device of this invention is not restricted to a particular size and thus, each sensor 30 can easily be sized so that it senses only one SKU space.

Preferably, the item monitoring system is able to monitor a large number of SKUs frequently. As is apparent to those skilled in the art, the data rate of the item monitoring system 10, which includes the data rate of the communication network and the data rate of the computer 24 illustrated in FIG. 1, will limit the amount of data per SKU, the number of SKUs and/or the frequency of collecting data. To elaborate, the number of SKUs multiplied by the amount of data per SKU multiplied by the frequency of data collection should not exceed the data rate of any one component of the item monitoring There are a large number of SKUs in large stores. Further, retailers want to monitor items often so that their information is as close to real-time as possible, which requires that the data collection is frequent. Therefore, it follows that a preferable way to keep the data rate of the item monitoring system 10 within the limits of the system components is to minimize the amount of data required per SKU at each collection event. To help minimize the amount of data per SKU that is processed by the item monitoring system 10, the output of each sensor 30 is preferably a simple variable value that provides information about the items it senses. By simple, it is meant that a single variable value can provide quantitative information without significant data manipulation, extensive calculations, large look-up tables, or comparison of a large number of data or values. The sensor 30 output signal could be an analog output, such as a voltage, current, resistance or frequency measurement. For example, a photosensitive sensor 30c that is a photovoltaic device provides a voltage response or current response based on the area of the sensor 30 that is covered by items (and thereby shielded or blocked from incident light). Therefore, a single voltage measurement from the photovoltaic device 30c is sufficient to provide a measure of the number of items present, preferably when the device 30c is calibrated as discussed in more detail below. A response that is linear or nearly linear relative to the number of items present in the space associated with the sensor 30 may be preferred to minimize data processing.

The item monitoring system 10 may include any type of sensor 30 known in the art that may sense a plurality of items in the space associated with the sensor 30. FIG. 3 is convenient for discussing at least three of the different preferred embodiments of the sensors in more detail. The three different preferred embodiments of sensor 30, which were briefly discussed above, are the capacitive sensor 30a, the sensor that includes a waveguide 30b, and the photosensitive sensor 30c. Each of these sensors is discussed in more detail below.

FIG. 3 illustrates one embodiment of capacitive sensors 30a on both the second shelf 12b and third shelf 12c. FIG. 3a illustrates a cross sectional view of a portion of one of the capacitive sensors 30a. The capacitive sensor 30a is preferably a planar, capacitive sensor, which is convenient for attaching to a surface, such as a shelf 12. More preferably, the capacitive sensor 30a is an interdigitated, planar capacitive sensor. Preferably, the planar capacitive sensor 30a includes non-metal substrate 96, such as a dielectric substrate, and a conductive material attached to the dielectric substrate. More preferably, the planar capacitive sensor includes two electrodes of conductive materials in the form of patterned metals 92, 94, such as copper or aluminum. Preferred patterns of such metal electrodes 92, 94 are illustrated in FIG. 3, however, other patterns are suitable.

A planar capacitor as illustrated in FIG. 3 may be fabricated by positioning electrodes 92, 94 on a non-metal substrate. In one embodiment, the electrodes 92, 94 consist of thin strips of adhesive-backed copper foil mounted on a thin sheet of plastic material. This type of structure is durable and relatively easy to fabricate by simple conversion processes. Other means of making suitable capacitive structures include etching of metal foil/polymer film laminates, and plating of metal patterns on flexible polymer substrates, optionally with the use of photoresists or printed resists to control the areas where metal is etched or deposited. Such additive, subtractive and semi-additive methods of fabricating metal patterns are well known to those skilled in the art. Alternatively, printing of conductive inks may form conductive patterns 92, 94. One suitable material for the non-metal substrate is a polycarbonate material commercially available under the tradename LEXAN available from GE Plastics located in Pittsfield, Mass. These methods of making patterned metal may be used in continuous manufacturing processes. Roll-to-roll manufacturing processes may be preferred because they provide efficient, large-volume, low-cost manufacturing.

FIG. 3a illustrates a cross sectional view of one embodiment of the planar capacitive sensor 30a. The patterned conductive material 92, 94 are attached to the dielectric substrate 96, optionally by a layer of adhesive. An optional layer of metal 98, such as copper or aluminum, is attached to the dielectric substrate 96 opposite the patterned electrodes 92, 94. The layer of metal 98 preferably covers the majority of the dielectric substrate 96. This layer of metal 98 functions as a ground shield for the sensor 30a. When the two patterned electrodes 92, 94, acting as conductors, are driven with opposite potentials, the opposing currents set up electric fields between, above and below the conductive electrodes 92, 94. Any change in the dielectric constant of the volume occupied by the electric field will cause a change in the capacitive reactance of the sensor 30a. Additionally any change in configuration of the electric field caused by, for example, metal objects will cause a change in the capacitive reactance of sensor 38. The electrodes 92, 94 are electrically connected to a capacitance meter inside the sensor electronics 50. One example of a suitable capacitance meter is commercially available from Almost All Digital Electronics located in Auburn, Wash. under model number UC meter IIB. This particular meter measures the output of an oscillator. The oscillator circuit of the meter operates at a frequency that depends upon the capacitance supplied by the capacitive sensor 30a. Further details, as well as an example of a suitable oscillator circuit, are found in Example 1 below. Measuring the frequency of an oscillator may be advantageous for detecting items that cause very small changes in the dielectric constant of the volume corresponding to the electric fields, for example, items that do not contain metal or items that are loosely packed and therefore in effect, contain a large portion of air.

In FIG. 1, every item in the group of items in the space associated with the capacitive sensor 30a has a dielectric constant value. Taken as a group, the items create a change in the electric field in the space associated with the capacitive sensor 30a, which ultimately affects the measured frequency of the oscillator. When a certain number of items are in the space monitored by the capacitive sensors 30a, this produces a particular electric field distribution in the space and as a result, there is a particular frequency measured on the oscillator. If the capacitive sensor 30a is calibrated, as discussed in more detail below, the item monitoring system 10 can determine the number of items in the space associated with the sensor 30a by the frequency measured. It is especially helpful when all the items in the group associated with the sensor 30a are relatively the same item, such as items with the same SKU, because such items all cause approximately the same change in electric field distribution.

An example of one embodiment of an item monitoring system including a planar capacitive sensor 30a, where the number of items is determined based on the change in frequency, is described in Examples 1 and 3 below. The conductive material 92 has a width that is designated by distance “a” on FIG. 3a. The conductive material 94 has a width that is designated by distance “b” on FIG. 3a. Distance “a” is preferably between 5 and 50 mm, and more preferably between 20 and 30 mm. Distance “b” is preferably between 5 and 50 mm, and more preferably between 20 and 30 mm.

The planar capacitive sensor 30a, in combination with sensor electronics 50, can be used to measure phase changes of the signal to determine the number of items in the sensor's space. Sensor electronics 50 injects a signal into sensor 30a and a portion of the signal is reflected back to the sensor electronics because of the presence of items. The sensor electronics 50 measure the phase difference between two signals, for example, by mixing the injected signal and the reflected signal together. The DC voltage level of the mixed output signal is related to the phase changes of the reflected signal, thus the phase changes are determined by measuring the DC voltage level of the mixed output signal. As with measuring frequency, the phase measurements are dependent on the capacitive created by the items in the space associated with the sensors. If the capacitive sensor 30a is calibrated, as discussed in more detail below, the item monitoring system 10 can determine the number of items placed in or removed from the space monitored by the sensor by the change in phase to the signal. It is especially helpful when all the items in the group associated with the sensor 30a are relatively the same item, such as items with the same SKU, because such items all have approximately the same affect in the resulting capacitive.

An example of an item monitoring system including a planar capacitive sensor 30a, where the number of items is determined based on phase measurements, is described in Example 2 below.

Alternatively, there may be two different types of items in the group of items in the space associated with the sensor 30a. Provided that the electrical properties of the two types of items are different enough that they will cause two distinctly different frequency changes or phase changes in sensor electronics 50, the item monitoring system 10 can determine which of the items have been removed from the shelf. Accordingly, any number of different types of items may be placed in the area monitored by the sensor 30a, so long as each type of item causes distinct frequency changes or phase changes and therefore, the system can determine what number and what type of item has been removed from the shelf by the customer. One example of this embodiment of the item monitoring system is described in Example 1.

It should be noted that some prior art capacitive sensors require mechanical deflection to generate a change in capacitance or resistance. However, the constant weight of objects placed on such a prior art sensor may cause permanent distortion to the sensor material, creating long-term reliability issues. The sensors and methods of this invention do not depend on weight or pressure changes and would not exhibit problems with mechanical failure or fatigue.

FIG. 3 illustrates one embodiment of waveguide sensors 30b on both the first shelf 12a and fourth shelf 12d. FIG. 3b illustrates a cross sectional view of one of the sensors 30b. The sensor 30b includes a first waveguide portion 80, which is a conductive material, such as copper or aluminum. The first waveguide portion 80 is attached, for example, by adhesive, to a second waveguide portion 82 that is a dielectric material. The sensor 30b includes a third waveguide portion 84 which is a conductive material attached to the second waveguide portion 82 opposite the first waveguide portion 80. The third waveguide portion 84 functions as a ground plate for the sensor 30b. Alternatively, the waveguide portions 80, 84 may be conductive inks or other conductive materials known in the art.

Waveguides may be fabricated by means similar to those described above for fabricating capacitive sensors. It may be preferred to use a roll of copper or other metal tape (metal foil plus adhesive) in a roll of a suitable width. Such a roll of tape can easily be fabricated on site, to produce sensors of customized sizes.

The waveguide sensor 30b and associated sensor electronics 50 detects the presence of the items in its corresponding space by using time-domain reflectometry techniques. Time-domain reflectometry (“TDR”) has traditionally been used for detecting discontinuities or fault locations on transmission lines or power lines. However, such techniques have not been used to determine the number of items in a designated area, such as on shelves in a store. In particular, in the waveguide design of this invention, there are fringing electric fields that extend above and to the sides of waveguide when an electromagnetic signal is sent through the waveguide. A signal generator, within the sensor electronics 50, is attached to the first waveguide portion 80, and the third waveguide portion 84, which may be optionally grounded through the sensor electronics. The signal generator sends out a short signal or pulse along the length of the waveguide, and the detector, which is within the sensor electronics 50 and connected to the waveguide, detects the signals reflected back along the waveguide. If items are in the space that contains the fringing electric fields around the waveguide, these items will disturb the transmission of the signal at that location and cause part of the signal to be reflected back to the detector. Any fraction of the signal that is not reflected by an item will be absorbed at the distal end of the waveguide. Therefore, by observing the number of reflections, the item monitoring system 10 can determine the number of items in the sensing space. It should be noted that the time elapsed between the time the signal is sent and the time a reflection is observed is related to the position of the item causing the reflection (i.e., the closer the item is to the signal generator, the shorter the time).

The waveguide 80 has a width that is designated by distance “c” on FIG. 3b. Preferably, the dimension “c” in FIG. 3b for first waveguide portion 80 ranges from 3 to 20 mm, dimension “d” of the second waveguide portion 82 ranges from 1.6 to 9.5 mm, and dimension “e” of the third waveguide portion 84 in FIG. 3 ranges from 15 to 100 mm. Dimension “f” in FIG. 3 of the waveguide portions 80, 82, 84 ranges from 0.05 to 2.0 meter. The design principles for waveguides are well known to those skilled in the art (see, for example, Pozar, David M., Microwave Engineering, Second Edition, John Wiley & Sons, Inc., New York, 1998, Chapter 3, pp. 160-167, which is hereby incorporated by reference). One example of one embodiment of a waveguide sensor including preferred measurements is described in Example 4 below.

FIG. 3 illustrates one embodiment of photosensitive sensors 30c on the first shelf 12a, mounted on the back panel 11, on third shelf 12c and on fourth shelf 12d. Photosensitive sensors 30c include a photosensitive material. Preferably, the photosensitive sensor 30c is a photovoltaic sensor 30c. The photosensitive material responds to light in the space associated with the sensor 30c by producing a current, voltage or resistance change. For example, when the sensor 30c, which is a photovoltaic sensor, is polled during one instance, the voltage is at one measurement. Then, if one of the items 37 is removed from the stack 36 on shelf 12b, because there is now one less item 37 in the stack 36, the photovoltaic sensor 30c can absorb more light, generating a different measurement of voltage during a second instance. It is this change in the measurements between the first instance and the second instance that indicates the number of items 37 in stack 36 has changed. Likewise, if an item 33 is removed from group 32 on top of photosensitive sensor 30c on first shelf 12a, the photosensitive sensor 30c will register a different measurement, after the item has been removed than it registered before the item was removed, thus indicating that an item has been removed.

One example of one embodiment of a photosensitive sensor 30c is described in Example 5 below.

Photovoltaic sensors can be fabricated from P-type and N-type semiconductors, such as, for example, doped amorphous silicon. Preferably, these devices are made in a roll-to-roll process on flexible substrates, such as those commercially available from Iowa Thin Films, located in Boone, Iowa.

Other suitable inorganic and organic materials also give a photoelectric response, that is, they display an electrical property that is a function of the amount of light they receive, and may be used in photosensitive sensors 30c. For example, electrical resistance may change with increasing light exposure. Many such materials are known in the art, for example, selenium and selenides, such as cadmium selenide, metal sulfides, such as cadmium sulfide, and mixtures of photosensitizing dyes with poly-N-vinylcarbazole with trinitrofluorenone. These may be deposited or coated onto substrates (including flexible substrates) by various processes (including roll-to-roll processes). Particles of photosensitive materials may also be formulated into inks, which may then be printed or deposited onto flexible substrates. Many materials, such as those that have been developed for applications, such as solar energy collection and electrophotography, may generally be used in photosensitive sensors of this invention.

Calibration may be preferred for photosensitive sensors that are used in ambient light, because shelf height, width, and depth and as a result, the intensity of incident ambient lighting can change from item to item, from location to location within a store, from store to store, and so on. For example, a shelf, particularly a shelf that is not a top shelf, may have higher ambient light intensity at the front edge of the shelf and lower ambient light intensity at the back edge of the shelf. For such a shelf lighting situation, it may be preferable to position a sensor so that it senses only a portion of the shelf over which there is less variation in light intensity, or alternatively two sensors may be optionally calibrated and used to detect items in one SKU that are in positions (i.e., front and back) that have different ambient light intensities.

Optionally, each sensor 30 may be calibrated during the installation process and/or at one or more times after the initial installation process. Calibration may provide more accurate sensing or more accurate threshold-setting, or provide for detection of additional states. For example, consider the photosensitive sensor 30c, which is sensitive to ambient light. Since different stores or even different locations within a store may have different amounts of ambient light, an uncalibrated photosensitive sensor 30c may be designed and set to detect two states (“high” and “low”) over a wide range of conditions. With calibration to a particular environment, it may be possible that five states (“full,” “high,” “medium,” “low” and “empty”) are detected or any number of states. It may also be desirable to calibrate sensors 30 for specific SKUs, which might vary in size, electromagnetic properties and so on.

One preferred procedure for calibration of the sensors 30 includes the steps of: a) measuring a first signal from the sensor 30 after installation in a SKU space, but before any items are placed into the SKU space; b) setting the first signal as “empty” by the system software; c) filling the SKU space with the SKU items such that the entire sensor area is full of the SKU items; c) measuring a second signal from the sensor 30; and d) setting the second signal as “full” by the system software. The signal associated with other states may be determined by interpolation between the empty and full state without the need for further calibration measurements. Optionally, additional measurements may be taken for more states between the signals for “empty” and “full.”.

Calibration may be accomplished with sensors 30 that provide linear or non-linear responses over the range of “empty” to “full,” or may be accomplished with different numbers of SKU items (such as just one), or may be accomplished with only one in situ signal measurement, or may be accomplished with the use of devices other than the sensor (for example, ambient light intensity could be measured with a light meter) or may be accomplished in advance of installation, such as pre-calibration in a factory setting. Other calibration variations will be apparent to those skilled in the art.

Information may be gathered from each sensor 30 (i.e., about each type of SKU) at periodic intervals. Information may be gathered almost constantly or it may be gathered less frequently. Preferably, information will be gathered at intervals ranging from one minute to one day. It may be desirable to gather information at regular intervals, or it may be desirable to collect information at times to be determined by an individual such as the store manager, or when other systems or events trigger a need for information gathering. For example, software may be employed in the item monitoring system 10 to examine hourly point-of-sale data, which may detect a trend or state that triggers a command to gather shelf inventory data immediately. In another example, a store manager may wish to send a command to gather shelf inventory data immediately after a random event; for example, a story appears in the local newspaper touting the benefits of a particular product. Or a store manager may wish to gather specific information during planned events, such as information about multiple store locations for a specific SKU that is part of a sale or promotion.

The number and/or complexity of steps in the optional calibration process may be reduced or the need for calibration may even be eliminated, and thereby the amount of data processing may be reduced, if the sensors 30 are pre-calibrated and/or manufactured to sufficiently tight tolerances. In such latter cases, it is possible for the computer database to contain information on the sensor response that correlates to a certain number of items of a particular SKU, prior to installation of a system in a particular store. This information may be easily stored and retrieved per SKU number during or after installation, thus avoiding in situ calibration steps.

The item monitoring system 10 provides quantitative-related information that is sufficient to distinguish between at least two inventory states, such as “high” and “low.” It is within the scope of this invention to set different thresholds for “high” and “low”, but as an example, “high” might be defined as any amount of items greater than 40% of the full capacity of a SKU space, and “low” might be defined as any amount of items less than 40% of the full capacity of that SKU space. Preferably, the system will provide the user with the ability to choose from a range of threshold values from 5% to 95%. As previously discussed, it is not as useful to the retailer to detect only “empty” (and, by inference, “not empty”) because when the “empty” signal is generated, the item is already out-of-stock and will remain out-of-stock for some period of time (at least the time it takes to get more inventory to the shelf). Thus, item monitoring system 10 is able to detect varying inventory levels per SKU space, including a “low” state that is non-zero or non-empty. Quantitative information may be as accurate as an actual count of the number of items in the space of each sensor 30.

Preferably, an SKU space will be at least partially monitored by a sensor 30. That is, the sensor 30 is preferably larger than the size of the individual objects of a SKU to be sensed and is responsive to objects in some portion of a space associated with the sensor 30. Some retailers may prefer to place items only on the front half of a shelf. Alternatively, the shelves may be spring-loaded or gravity-fed shelves or displays, wherein items are moved to the front of the shelf by springs or gravity as soon as other items are removed from the front of the shelf. Thus it may be advantageous to arrange a sensor on a selected portion of an SKU space, such as a front portion.

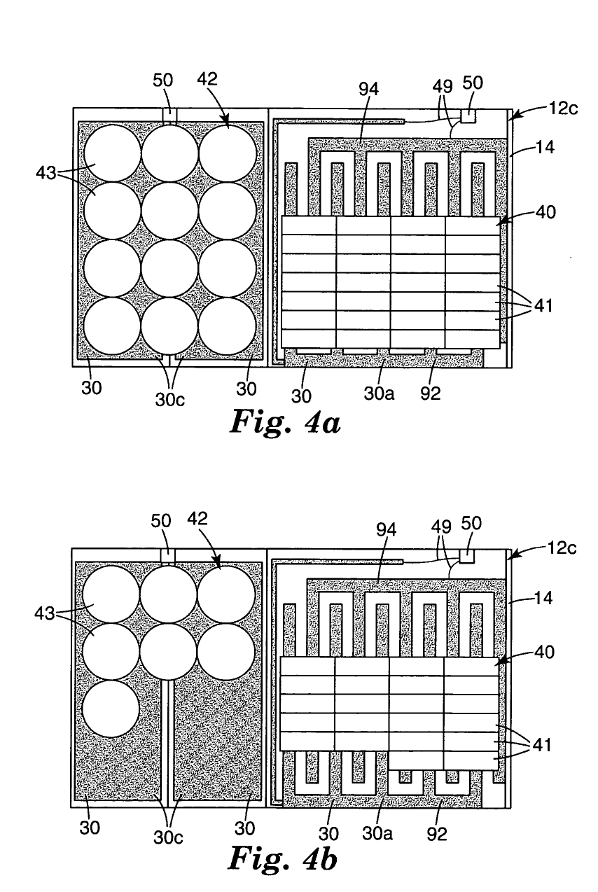

FIGS. 4a and 4b, respectively, illustrate the top of the third shelf 12c before and after a customer has removed items. In FIG. 4a, items 41 are arranged in a group 40 towards the front of the shelf 12c, closest to the customer. In this arrangement, the sensor 30a of the item monitoring system 10 could be calibrated to read “full.” In FIG. 4b, six of the items 41 have been removed. Since the sensor 30a was calibrated to read “full” with twenty-eight items in its space, the system will determine a reading of about 79% full, or this determination could be rounded to the nearest quartile to read about 75% full. When enough items 41 are removed from the shelf 12c, for example, fourteen items 41 in total, the item monitoring system 10 may read that the SKU space is now about 50% full. Once the SKU space drops below 50% full, the item monitoring system may send a signal to the user that items 41 need to be restocked on shelf 12c, if 50% is selected as the threshold level for sending a restocking message.

A single sensor 30 may be sized and positioned so as to sense all or only some of the space occupied by a single SKU. For example, as illustrated in FIG. 4a, items 43 of the same SKU are arranged in group 42, which is monitored by two sensors 30c. Four of the items 43 are in the space of both sensors 30c, specifically placed along the area where the two sensors 30c meet. Appropriate calibration and data processing may be used to rectify the data from two sensors to give a quantitative indication of inventory. For example, he combined output of sensors 30c are together calibrated to read as “full” in the arrangement illustrated by FIG. 4a. In FIG. 4b, five of the items 43 have been removed by the customer from shelf 12c. Since, the combined output of the two sensors 30c were calibrated to read “full” with twelve items 43, the combined output of the sensors 30c together will be interpreted to mean about 58% full with seven items, or this result may be rounded to read about 60% full. When enough items 43 are removed from the shelf 12c, for example, nine items 43 in total, the combined output of sensors 30 together will be interpreted to 25% full, and send a message to the user that items 43 need to be restocked on the shelf 12c (if the user had selected 25% as the threshold for sending a restocking message). Alternatively, each sensor 30c can be individually calibrated to read “full” when each sensor 30c includes a total of four entire items 43 and half of four additional items 43, for which the collective sensor response is calibrated to mean six items 43. In this arrangement, the sensor 30c on the left in FIG. 4b will sense a total of four items 43 (three entire items 43 and two half items 43) and read “66% full”. The sensor 30c on the right in FIG. 4b will sense a total of three items 43 (two entire items 43 and two half items 43) and read “50% full”.

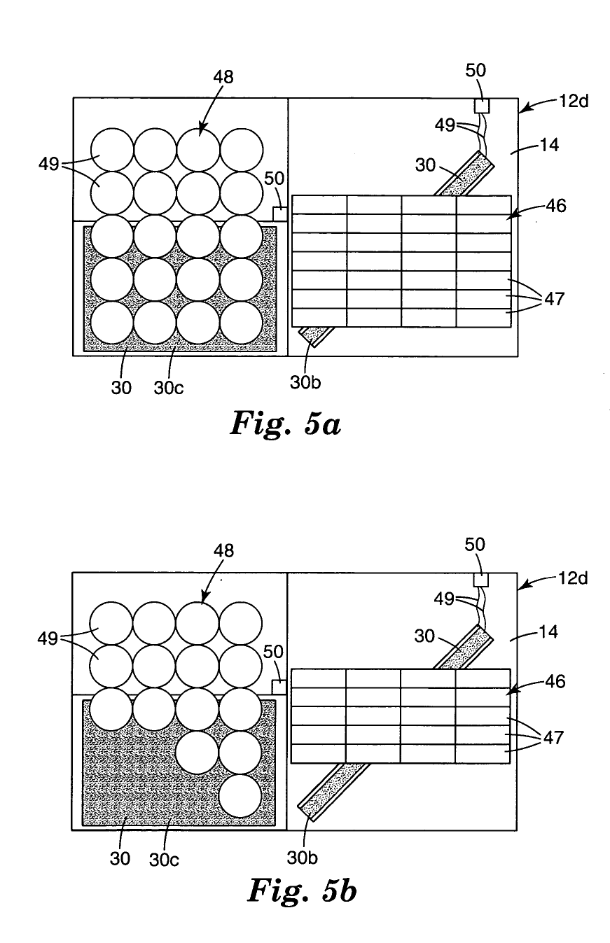

FIGS. 5a and 5b, respectively, illustrate the top of the fourth shelf 12d before and after a customer has removed items. In FIG. 5a, sensor 30c monitors only the front half of the shelf 12d. Typically, customers will remove items from the front area of the display or shelf, selecting items further back once the front area of the shelf is empty. When the front area of the shelf is completely full, as is illustrated in FIG. 5a, the sensor 30c may be calibrated to mean that the area associated with the sensor is “100% full.” In FIG. 5b, five of the items 49 have been removed. Since the sensor 30c was calibrated to read “full” with twelve items 49 in its associated sensing space, the sensor 30c will provide an output that can be interpreted to mean that the space associated with the sensor is now about 58% full, or this interpretation could be rounded to mean about 60% full. When enough items 49 are removed from the shelf 12d, for example, twelve items 41 in total, the sensor 30c output may be interpreted to mean that the space associated with the sensor is now 100% empty. The item monitoring system may then send a message to the user that items 49 need to be restocked on shelf 12d. Utilizing a sensor covering only part of a SKU space may be especially advantageous when the inventory level corresponding to the empty sensor space is about the same as a desired threshold level for restocking. Alternatively, the item monitoring system may send a message to the user that it is time to move items forward to the front of the shelf, and may be useful for those situations where a store owner or store manager prefers to keep shelves “faced” (that is, with all items in a SKU space positioned as close to the front of the shelf as possible, so as to create a neat appearance and to make it convenient for customers to reach items). Note that, in this particular example, there may be items 49 on the shelf 12d for a customer to purchase, even when the space associated with the sensor is interpreted by the system to be empty.

In FIG. 5a, items 47 are arranged in a group 46 towards the front of the shelf 12d, closest to the customer. In this arrangement, the sensor 30b of the item monitoring system 10 could be calibrated to read “full.” In FIG. 5b, eight of the items 41 have been removed. Since the sensor 30b was calibrated to read “full” with twenty-eight items in its space, the sensor 30a will read about 71% full or could be rounded to read 70% full. When enough items 47 are removed from the shelf 12c, for example, fourteen items 47 in total, the sensor 30b or the item monitoring system 10 may read that the SKU space is now about 50% full. Once the SKU space drops below 50% full, the item monitoring system may send a signal to the user that items 47 need to be restocked on shelf 12d.

Sensor 30b in FIGS. 5a and 5b is arranged diagonally across the SKU space. Sensor 30b will only detect items that are within the fringing fields adjacent the first waveguide portion 80. Thus, most of the items in the SKU space will not be directly measured. However, customers generally remove items from the front of the shelf first, and while the patterns of removal are not exactly the same each time, they are sufficiently consistent so that one can measure only those items in close proximity to first waveguide portion 80, making the assumption that each row of items is removed entirely before items are removed from the row behind it, and determine the approximate number of items in the SKU space to a useful level of accuracy.

Each SKU space is illustrated in the figures as occupying about half of a shelf, but it should be understood that generally a single SKU may occupy a range of widths on a shelf from as small as about 1 cm wide up to the full width of the shelf. Sensors of this invention may be of various sizes to fit the wide variety of SKU sizes and shapes. Even if only part of the space occupied by a single SKU contains a sensor, it is still able to provide useful information concerning the need to restock.

Preferably, the item monitoring system 10 provides current or real-time information about the number of physical objects associated with each sensor 30, at the SKU level. Real-time information is defined as information that accurately represents the true state during the time data is gathered and processed, or within a small amount of time of the time that the data is gathered and processed. In other words, the information is current or very nearly current. The definition of a “small amount of time” is dependent on the application, but will generally be less than one-half, preferably less than one-tenth, of the reaction time required by the retailer for any physical action to correct an out-of-stock or low-stock situation. For example, it if takes 20 minutes to move an item from a store back room to a shelf, it would be considered real-time information to know what the status of that shelf was within ten minutes. In actual use, a retailer may decide to gather real-time information infrequently, for example, one time per day, but nonetheless the information is real-time because it accurately reflects the status of the SKU at the time it was gathered. As will be apparent to those skilled in the art, the exact performance of the system will depend on the number of SKUs monitored and the amount of data per SKU. It may also be preferred to gather information from two or more closely spaced times to improve the accuracy of the information concerning the inventory over a longer period of time. For example, to overcome the effect of customer-generated shadows on a photosensitive sensor 30c, data may be gathered at a first time and at a second time 20 seconds after the first time, and the results compared to provide inventory information that is representative of a state at a time interval including both the first time and the second time.

The item monitoring system 10 of this invention can easily be installed at several locations within a store, for example, on a shelf, on an end cap, and at a checkout stand. It may be preferable to monitor certain locations because they are prominent and/or frequently result in higher sales. Further, it may be useful to monitor items that are displayed for sale in several locations in the store. When items are on sale or are being promoted with coupons, advertisements and the like, for example, they are often displayed in several locations within the store (including the usual location for that SKU, but typically some additional, prominent locations). It may be preferable to use the item monitoring system of this invention to determine not only that restocking is necessary, but also to determine the locations which are going out of stock first (that is, the locations from which items are selling most rapidly).

Those skilled in the art will recognize that durability, sensitivity to specific retail items, store appearance, installation difficulty, etc. will result in certain types of sensors 30a, 30b, 30c being preferred for certain items or stores. Some retailers may require the use of two or more types of sensors 30a, 30b, 30c to cover a particular group of items within the same SKU.

To simplify manufacturing and installation, it may be preferable to provide a set of sensors 30 of one or more standard sizes. For one example, a standard sensor 30 may be 10 cm wide and 30 cm long, and a multiplicity of these sensors might be positioned on a shelf with the 10 cm edge flush with the front edge of the shelf and with a spacing of 2 cm between each sensor. Other examples will be apparent to those skilled in the art, utilizing sensors of different widths and lengths, positioned with or without spacing. Some spacing between sensors may be preferable to reduce interactions between sensors, to reduce the number of sensors, or to reduce the need to precisely locate sensors during installation.

With the use of standard-sized sensors, a particular retailer might find that a small number of SKU spaces require two or more sensors, or a single sensor might include parts of two or more SKU spaces (particularly for items that are very small and for which small numbers of items are maintained in stock, leading to a very small volume for that SKU). Even so, the use of standard size sensors provides information about inventory levels of the majority of SKU items at the SKU level. In rare cases where, because of standard-sized sensors or other factors, several sensors are positioned in proximity to a single item, redundant sensors can easily be ignored or turned off by the system.

The sensors of this invention may be manufactured in roll-to-roll processes, and may also be supplied to installation sites in roll form. This may be advantageous because roll-to-roll processes are generally efficient and suitable for large volume, low cost manufacturing operations. Furthermore, rolls of sensors are easily handled and/or customized at installation sites. However, sensors of this invention may also be manufactured and supplied as sheets, including pre-cut sheets of standard sizes, or in pre-cut panels or other forms that will enable rapid installation.

To provide an unobtrusive appearance or to make a SKU item more noticeable (for example, for purposes of advertising or retail customer convenience), additional materials, components or devices such as films, printed rolls or sheets of film or paper, displays, boxes, cases, lights and the like may be used with the sensors 30.

It is within the scope of this invention for the item monitoring system 10 to further include specialized sensing devices with different features or employing different technologies, to provide inventory information on specialized items such, as very expensive consumer electronics. Such specialized sensing devices may incorporate one or more sensors to detect a single item, or may require specialized tagging of items, such as RFID tags on each item. It may be advantageous to add such specialized sensing devices to the system 10, for example, to take advantage of the communication network.

Though the item monitoring system of the present invention is particularly suitable for use in a retail establishment where there are a large number of individual items and SKUs that are highly variable with respect to physical properties, value and quantity, the item monitoring system of the present invention may also be used in industrial, manufacturing and business environments, such as parts stockrooms, tool storage areas, equipment storage areas and the like, stockroom or storage areas in institutions such as hospitals, and storage areas for supplies in offices and pharmacies. The item monitoring system of the present invention may also be useful in back room storage areas of retail establishments and in warehouses and distribution centers.

A variety of methods are useful with the item monitoring system 10. One method includes the steps of: a) providing a sensor 30; b) placing a plurality of items in a first amount of space associated with the sensor 30; c) sensing the plurality of items in the first amount of space a first instance with the sensor; and d) determining the quantity of items within the first amount of space associated with the steps. The sensor may sense the plurality of items in the first amount of space associated with the sensor a second instance, for example, a few minutes later or an hour later than the first instance, and determine the quantity of items in the first amount of space during this second instance, and compare it to the quantity of items that were in the first amount of space during the first instance, to see if the number of items has changed. The information gathered during the first instance and second instance from the sensor 30 can be sent by the sensor electronics 50 through the communications network to the computer 24.

The computer 24 may process the information received from the first instance and the second instance to determine the current number of items on the shelf affiliated with that sensor. The computer may have certain thresholds set for sending alarms to a user, if the number of items falls below the thresholds. For example, the computer may signal to a user whether the quantity of items in the first area of space is greater than a first quantity, for example, 50%, or below the first quantity. Alternatively, the computer may signal to a user whether the quantity of items in the first area of space is greater than a first quantity, for example 75%, less than the first quantity and greater than a second quantity, for example 50%, or is less than a second quantity.

The operation of the present invention will be further described with regard to the following detailed examples. These examples are offered to further illustrate the various specific and preferred embodiments and techniques. It should be understood, however, that many variations and modifications may be made while remaining within the scope of the present invention.

### EXAMPLE 1

In this Example, an interdigitated capacitor “(IDC)” capacitive sensor 30a, as illustrated in FIGS. 3 and 3a, was used. The capacitor was comprised of two sets of interlaced conductors 92, 94 mounted on a dielectric substrate 96 with a ground shield 98 on the opposite side of the substrate. The two sets of conductors were driven with opposite potentials that resulted in opposing currents setting up electric fields between the conductors.

The sensor of this Example was constructed using 2.54 cm wide (dimension “a” illustrated in FIG. 3a) copper foil tape for the conductors 92, 94 and a 60.96 cm×121.92 cm×0.159 cm sheet of clear polycarbonate material available from GE Plastics, located in Pittsfield, Mass. under tradename LEXAN as the dielectric substrate 96. The conductor spacing was 2.54 cm (dimension “b” illustrated in FIG. 3a). This IDC structure was electrically connected to the oscillator circuit of an inductance/capacitance meter, Model L/C Meter IIB commercially available for Almost All Digital Electronics, located in Auburn, Wash. The circuit diagram below presents the oscillator circuit of the meter.

[image]

The oscillator circuit of the meter operates at a frequency determined by the circuit's components C1 and L1. With the sensor electrically connected to the meter, the oscillator circuit of the meter operates at a frequency determined by the circuit's components C1, L1 plus the additional capacitance supplied by the sensor. The change in frequency of the oscillator was monitored as objects were placed on and removed from the surface of the sensor. For this circuit, a change in capacitance of 0.01 pF produced a change in frequency of approximately 5 Hz.

Using the interdigitated capacitor sensor integrated to a metal shelving unit and to a laminate desktop, boxes sold under tradename MARVELOUS MARSHMALLOW MYSTERIES dry cereal, size 14 ounces (396 g), distributed by Target Corporation, Minneapolis Minn., and bottles of DEEP CLEAN TIDE liquid laundry detergent, size 100 fluid ounces (2.95 liters), manufactured by Proctor and Gamble, Cincinnati, Ohio upon being placed on the sensor, were sensed. The sensor sensed all items regardless of the size, shape, or materials presented by each of the items. The frequency output values per type and number of items sensed is presented in Tables 1 and 2. The frequency output data presented in Table 2 showed that removal of one bottle of liquid detergent provided an average frequency change of 2896 Hz.

TABLE 1
Measurement of Frequency Changes
per Number of Boxes of Cereal.

| Boxes of | Frequency | Delta per | Total |
|---|---|---|---|
| Cereal | (Hz) | Box (Hz) | Delta (Hz) |
| 10 | 447276 | — | 0 |
| 9 | 447637 | 361 | 361 |
| 8 | 448240 | 603 | 964 |
| 7 | 448845 | 605 | 1569 |
| 6 | 449332 | 487 | 2056 |
| 5 | 450432 | 1100 | 3156 |
| 4 | 450800 | 368 | 3524 |
| 3 | 451417 | 617 | 4141 |
| 2 | 451911 | 494 | 4635 |
| 1 | 452408 | 497 | 5132 |
| 0 | 453280 | 872 | 6004 |

TABLE 2
Measurement of Frequency Changes per Number
of Bottles of Liquid Detergent.

| Bottles of | Frequency | Delta per | Total |
|---|---|---|---|
| Detergent | (Hz) | Bottle (Hz) | Delta (Hz) |
| 8 | 418684 | — | — |
| 7 | 421973 | 3289 | 3289 |
| 6 | 425238 | 3265 | 6554 |
| 5 | 429003 | 3765 | 10319 |
| 4 | 431785 | 2782 | 13101 |
| 3 | 434733 | 2948 | 16049 |
| 2 | 436843 | 2110 | 18159 |
| 1 | 439896 | 3053 | 21212 |
| 0 | 441852 | 1956 | 23168 |

Using the interdigitated capacitor sensor of this Example, the inventory status of two different types of items was determined. Boxes of Arm & Hammer FABRICARE powdered detergent, 4.89 lb (2.22 kg) size, made by Dwight & Clark Co. Inc., Princeton, N.J. and bottles of Arm & Hammer HEAVY DUTY liquid detergent, one gallon (3.78 l) size, Princeton, N.J. were placed on the same sensor arranged in rows from one edge of the sensor to the opposing edge, i.e. from front (position number 1) to back of the sensor (position number 5 for powdered, number 4 for liquid). The powdered detergent boxes were placed in one row and the liquid detergent was placed in a second row. The frequency output data per type of item removed and the position, from which the item was removed, is presented in Table 3.

TABLE 3
Measurement of Frequency Change per Type of Item
Removed and Position from which it was Removed
on a Single Interdigitated Capacitor Sensor.

| Position of Box | Delta | Position of | Delta |
|---|---|---|---|
| of Powdered | Frequency | Bottle of | Frequency |
| Laundry | Per Box | Liquid Laundry | Per Bottle |
| Detergent | (Hz) | Detergent | (Hz) |
| 1 | 676 | 1 | 2037 |
| 2 | 1355 | 2 | 2380 |
| 3 | 1355 | 3 | 2380 |
| 4 | 1468 | 4 | 3412 |
| 5 | 1468 | — | — |

### EXAMPLE 2

In this example, using the same IDC sensor used in Example 1, a signal was injected into the sensor, and the phase change of the reflected signal was determined. This was accomplished by determining the phase difference between two signals; a reference signal, i.e. the signal injected into the sensor, and a reflected signal. The DC (direct current) term of the mixed output signal obtained from mixing the reference signal and the reflected signal from the sensor together was measured. This provided the phase change difference as the DC term is proportional to the phase change of the reflected signal. A suitable phase detector circuit, which is well known in the art, may be found in Floyd M. Gardner, Ph.D., Phaselock Techniques, Second Edition, 1979, John Wiley & Sons, Inc., New York, N.Y., pp. 106-125, which is hereby incorporated by reference.

The desired operating frequency range of the phase detector circuit of this example was 5-15 MHz. The desired operating frequency range is where the impedance of the shelf sensor is between the capacitive and the inductive region frequency range, which depends on the structure of the sensor and the type of items on or near the sensor. Maximum changes in phase occur when the impedance of the sensor interchanges between being capacitive and inductive as items are added to or removed from the volume over which the sensor senses.

Phase changes in the reflected signal corresponding to the DC voltage level of the mixed output signal as bottles of DEEP CLEAN TIDE liquid laundry detergent, size 100 fluid ounces (2.95 liters), manufactured by Proctor and Gamble, Cincinnati, Ohio, were taken off the shelf are shown in Table 4. The phase change was measured by measuring the DC voltage output of the mixed output signal.

TABLE 4
Phase Change Values Corresponding to DC Voltage Output
Data per Number of Liquid Detergent Bottles

| Bottles of | DC voltage | Approximate phase |
|---|---|---|
| Detergent | output (V) | change (°) |
| 8 | −0.055 | 93.15 |
| 7 | −0.06 | 93.44 |
| 6 | −0.067 | 93.84 |
| 5 | −0.071 | 94.07 |
| 4 | −0.079 | 94.53 |
| 3 | −0.089 | 95.11 |
| 2 | −0.101 | 95.8 |
| 1 | −0.109 | 96.26 |
| 0 | −0.119 | 96.83 |

### EXAMPLE 3

In this example, using the same IDC sensor used in Example 1, except no copper foil 98 was present on the bottom side of the LEXAN sheet. The IDC sensor was placed on a metal shelf. The inductance/capacitance meter used was the same as in Example 1.

Twenty-four cans sold under tradename CAMPBELL'S condensed tomato soup, 10¾ ounce size (305 g), made by Campbell Soup Company, Camden, N.J. were placed in a portion of their corrugated cardboard shipping carton; i.e. the original carton was cut and modified so that the soup cans were supported by the bottom and three sides of the original carton, but the top and front side of the carton were removed. The thusly modified carton and the twenty-four soup cans were then placed on top of the sensor, such that the bottom of the carton was between the soup cans and the sensor.

A frequency value for a full shelf (24 cans of soup on the shelf) was measured. Soup cans were removed two at a time from various locations, and the change in frequency from a full shelf frequency value was measured. The frequency change measured data is shown in Table 5. The average frequency change is also shown, between 24 cans and 0 cans.

TABLE 5
Phase Change Measurements of Cans of Soup in a Carton.

| | | | | | | | Average Delta |
|---|---|---|---|---|---|---|---|
| Cans of | Delta Frequency | | | | | | per Number |
| Soup | (Data shows cans removed from multiple | | | | | | of Cans |
| Remaining | locations on a cardboard carton) | | | | | | Remaining on |
| on Shelf | (Hz) | | | | | | Shelf (Hz) |
| 24 | — | — | — | — | — | — | — |
| 22 | 329 | 219 | 109 | — | — | — | 219 |
| 20 | 768 | 878 | 658 | 548 | 436 | 328 | 603 |
| 18 | 989 | 1099 | 1320 | 879 | 768 | 658 | 952 |
| 16 | 1874 | 1985 | 1430 | 1209 | — | — | 1625 |
| 14 | 2429 | 1652 | — | — | — | — | 2041 |
| 12 | 3099 | 2207 | — | — | — | — | 2653 |
| 10 | 3435 | 3772 | 2764 | — | — | — | 3324 |
| 8 | 4223 | 3435 | — | — | — | — | 3829 |
| 6 | 4674 | 4787 | 5344 | 3997 | — | — | 4701 |
| 4 | 5468 | 5582 | 6038 | 5127 | 5014 | — | 5446 |
| 2 | 6495 | 5924 | — | — | — | — | 6210 |
| 0 | 7299 | 7414 | 7761 | — | — | — | 7491 |

### EXAMPLE 4

In this example, a microstrip waveguide sensor 30b, as shown in FIGS. 3 and 3b, was used. The microstrip waveguide was formed as follows. A piece of copper foil 80, width 1.6 cm (dimension c), length 1.219 m (dimension f), was applied to the top of a piece of LEXAN polycarbonate material 82 available from GE Plastics, Pittsfield, Mass., as an dielectric substrate. The dimensions of the LEXAN material were 1.219 m by 0.305 m by 6.4 mm (dimension “d”). The copper foil 80 was positioned such that an imaginary line bisecting the copper foil 80 along its length was positioned directly over an imaginary line bisecting the piece of LEXAN material 82 along it's length, i.e. the copper foil 80 was centered lengthwise over the piece of LEXAN material 82. Another layer of copper foil 84, 72 mm (dimension “e”) by 1.219 m (dimension “f”) was applied to the bottom side of the dielectric material as a ground plane. This copper foil was also centered lengthwise under the piece of LEXAN material.

One end of the microstrip waveguide was connected to a Hewlett-Packard Model 8720C network analyzer from Hewlett-Packard, Palo Alto, Calif. The network analyzer generated a wide frequency band signal that was sent (injected) from one end of the waveguide through the top portion of the waveguide 80. A 50-ohm load termination was connected at the other end of the top portion of the waveguide. (The 50 ohm load termination matches the waveguide characteristic impedance. Thus, when no items are placed on the waveguide, the injected signal is absorbed by the 50 ohm load and no reflected signal occurs.)

Four boxes of MARVELOUS MARSHMALLOW MYSTERIES dry cereal, size 14 ounces (396 g), distributed by Target Corporation, Minneapolis Minn. were placed along the waveguide at four locations. The cereal boxes placed along the waveguide caused perturbations of the field along the waveguide at each location of a cereal box, resulting in reflection of part of the injected signal back at each different location. The network analyzer then detected these perturbations of the signal along the waveguide. The network analyzer determined the time series information of each reflected signal by calculating the inverse Fourier Transform of each reflected signal. The calculated time series information for each reflected wave, in this example each of which represents the location of a cereal box along the waveguide, are shown in Table 6.

TABLE 6
Items Observed by Reflected Waveforms in a Waveguide.

| Position of Cereal Box | Time to receive reflected |
|---|---|
| (cm from signal end) | signal (ns) |
| 8 | 1.5 |
| 45 | 5.2 |
| 69 | 7.8 |
| 84 | 9.2 |

Note, the time to receive each signal reflected from an item is related to the distance of the item from the point at which the signal is injected.

### EXAMPLE 5

In this example, a photovoltaic sensor 30c, as shown in FIG. 3, was used. Three photovoltaic solar panels under tradename POWERFILM, product number MP7.2-150 and one photovoltaic solar panel under tradename POWERFILM, product model number MP7.2-75 from Iowa Thin Film Technologies, Boone, Iowa, were connected in parallel. According to the photovoltaic solar panel product specifications from Iowa Thin Film Technologies, in full sunlight, the these four solar panels combined will generate 525 mA of electric current at 7.2 volts.

A shelf section of area 20 inches (50.8 cm) wide by 10 inches (25.4 cm) deep was used. The solar panels were integrated with the shelf section (laid on top of the shelf section) and covered with a sheet of LEXAN material that was 1/8 inch (0.32 cm) thick. A voltmeter was connected to the panels. The voltmeter was a model 926 digital multimeter from R.S.R. Electronics, Inc., Avenel, N.J.

The light source was typical indoor fluorescent lighting.

The composite of a shelf section with photovoltaic panels covered by a sheet of LEXAN material, i.e. the sensor, was placed on top of a storage unit, such that the sensor was illuminated with ambient room light, and that the sensor did not experience any shadows from other structures impeding direct illumination of the sensor by the ambient light. The sensor was positioned so that it was not directly underneath the fluorescent light fixtures in the ceiling of the room. In this lighting arrangement, the sensor produced a signal of 0.30 V. Six boxes of a macaroni and cheese food product 12.9 ounce size (366 g) under tradename EASYMAC produced by Kraft Foods, Northfield, Ill., were placed on the sensor, one at a time. Six boxes about completely covered the sensor. The measured output voltage of the sensor according to the number of boxes present on the sensor are shown in Table 6.

TABLE 6
Measurement of Voltage Output
per Number of EASY MAC boxes.

| Number of Boxes of | Sensor output |
|---|---|
| EASY MAC | (VOLTS) |
| 0 | 0.30 |
| 1 | 0.27 |
| 2 | 0.24 |
| 3 | 0.20 |
| 4 | 0.15 |
| 5 | 0.07 |
| 6 | 0.0 |

With the sensor positioned so that it was directly underneath a fluorescent lighting fixture, the measured output voltage of the empty sensing device was 3.85 V. Twenty-four cans of insect repellant, 6 ounce size metal aerosol cans (170 g), produced by 3M Company, St. Paul, Minn., under tradename ULTRATHON were placed on the panels in 4 rows of 6 cans each. The measured output voltage of the sensor according to the number of aerosol cans present on the sensor are shown in Table 7.

TABLE 7
Measurement of Voltage Output per
number of ULTRATHON aerosol cans.

| Number of cans of | Photovoltaic output |
|---|---|
| ULTRATHON | (VOLTS) |
| 0 | 3.85 |
| 2 | 2.70 |
| 4 | 2.50 |
| 6 | 2.30 |
| 8 | 2.10 |
| 10 | 1.95 |
| 12 | 1.50 |
| 14 | 1.10 |
| 16 | 0.52 |
| 18 | 0.50 |
| 20 | 0.44 |
| 22 | 0.40 |
| 24 | 0 |

The test and test results described above are intended solely to be illustrative, rather than predictive, and variations in the testing procedure can be expected to yield different results.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. An item monitoring system, comprising:
a sensor, wherein the sensor senses a plurality of items in a first amount of space associated with the sensor, wherein the sensor is capable of sensing both items containing metal and items containing no metal;
a communications network; and
a computer, wherein the computer receives information from the sensor through the communications network.

2. The item monitoring system of claim 1, wherein the sensor senses the plurality of items in the first amount of space and sends related information to the computer through the communications network.

3. The item monitoring system of claim 2, wherein the computer determines the quantity of items within the first amount of space.

4. The item monitoring system of claim 3, wherein the sensor senses the plurality of items in the first amount of space a first instance, wherein the sensor senses the plurality of items in the first amount of space a second instance, and wherein the computer compares the information from the first instance and the second instance to determine changes in the quantity of items within the first amount of space.

5. The item monitoring system of claim 2, wherein the sensor determines the quantity of items within the first amount of space.

6. The item monitoring system of claim 5, wherein the sensor senses the plurality of items in the first amount of space a first instance, wherein the sensor senses the plurality of items in the first amount of space a second instance, and wherein the sensor compares the information from the first instance and the second instance to determine changes in the quantity of items within the first amount of space.

7. The item monitoring system of claim 1 further comprising a shelf, wherein the sensor is attached to the shelf.

8. The item monitoring system of claim 1, wherein the sensor is positioned such that the first amount of space is above the sensor.

9. The item monitoring system of claim 1, wherein the sensor is positioned such that the first amount of space is below the sensor.

10. The item monitoring system of claim 1, wherein the sensor is positioned such that the first amount of space is beside the sensor.

11. The item monitoring system of claim 1, wherein the response of the sensor is independent of the weight of the items in the first amount of space.

12. The item monitoring system of claim 1, wherein the item monitoring system computer signals to a user whether the quantity of items in the first area of space is greater than or equal to a first quantity or less than the first quantity.

13. The item monitoring system of claim 1, wherein the item monitoring system signals to a user whether the quantity of items in the first area of space is greater than or equal to a first quantity, less than the first quantity and greater than or equal to a second quantity, or is less than a second quantity.

14. The item monitoring system of claim 1, wherein the computer sends information to the sensor through the communications network.

15. The item monitoring system of claim 1, wherein the sensor comprises a planar capacitive sensor.

16. The item monitoring system of claim 15, wherein the planar capacitive sensor responds to changes in the electric field configuration in the first amount of space and sends related information to the computer through the communications network, and wherein the item monitoring system determines the quantity of items within the first amount of space.

17. The item monitoring system of claim 15, wherein the capacitive sensor includes electrodes attached to a non-metal substrate.

18. The item monitoring system of claim 17, wherein the electrode comprise patterned conductors.

19. The item monitoring system of claim 1, wherein the sensor comprises a waveguide.

20. The item monitoring system of claim 1, wherein the sensor comprises a photosensitive sensor.

21. The item monitoring system of claim 20, wherein the photosensitive sensor responds to changes in the amount of light in the first amount of space and sends related information to the computer through the communications network, and wherein the item monitoring system determines the quantity of items within the first amount of space.

22. The item monitoring system of claim 21, wherein when items are removed from the first amount of space, the amount of light of the first amount of space increases and produces a current, voltage, or resistance change in the photosensitive sensor.

23. The item monitoring system of claim 21, wherein the photosensitive sensor responds to the amount of light in the first amount of space a first instance and sends related information to the computer through the communications network, wherein the photosensitive sensor responds to the amount of light in first amount of space a second instance and sends related information to the computer through the communications network, and wherein the item monitoring system compares the information from the first instance and the second instance to determine changes in the quantity of items within the first amount of space.

24. The item monitoring system of claim 20, wherein the photosensitive sensor is a photovoltaic sensor.

25. The item monitoring system of claim 1, wherein a portion of the communication network is wireless.

26. The item monitoring system of claim 1, wherein the plurality of items within the first amount of space are all the same stock keeping unit.

27. The item monitoring system of claim 1, wherein the plurality of items within the first amount of space are a plurality of different stock keeping units.

28. The item monitoring system of claim 1, wherein the system includes a second sensor, wherein the second sensor senses a plurality of items in a second amount of space associated with the second sensor.

29. The item monitoring system of claim 1, wherein the sensor generates a variable value output that is related to the quantity of items in the first amount of space.

30. The item monitoring system of claim 29, wherein the variable value output may include frequency, phase, current, voltage, resistance, time, amplitude or combinations of such.

31. An item monitoring system, comprising:
a shelf;
a planar capacitive sensor attached to the shelf, wherein the capacitive sensor responds to changes in the electric field configuration in a first amount of space above the planar capacitive sensor by producing a frequency change in the capacitive sensor, wherein the capacitive sensor includes electrodes attached to a non-metal substrate, wherein the electrodes comprise patterned conductors, and
wherein the planar capacitive sensor is capable of sensing both items containing metal and items containing no metal;
a communications network, wherein a portion of the communication network is wireless; and
a computer, wherein the computer receives information from the planar capacitive sensor through the communications network;
wherein the planar capacitive sensor measures the frequency a first instance and sends related information to the computer through the communications network, wherein the planar capacitive sensor measures the frequency a second instance and sends related information to the computer through the communications network, wherein the computer compares the frequency from the first instance and the second instance to determine changes in the quantity of items within the first amount of space, and wherein the computer signals to a user whether the quantity of items in the first area of space is greater than or equal to a first quantity or less than the first quantity.

32. An item monitoring system, comprising:
a shelf;
a planar capacitive sensor attached to the shelf, wherein the capacitive sensor responds to changes in the electric field configuration in a first amount of space above the planar capacitive sensor by producing a phase change in the capacitive sensor, wherein the capacitive sensor includes electrodes attached to a non-metal substrate, wherein the electrodes comprise patterned layer conductors, and wherein the planar capacitive sensor is capable of sensing both items containing metal and items containing no metal;
a communications network, wherein a portion of the communication network is wireless; and
a computer, wherein the computer receives information from the planar capacitive sensor through the communications network;
wherein the planar capacitive sensor measures the phase a first instance and sends related information to the computer through the communications network, wherein the planar capacitive sensor measures the phase second instance and sends related information to the computer through the communications network, wherein the computer compares the phase from the first instance and the second instance to determine changes in the quantity of items within the first amount of space, and wherein the computer signals to a user whether the quantity of items in the first area of space is greater than or equal to a first quantity or less than the first quantity.

33. An item monitoring system, comprising:
a shelf;
a sensor attached to the shelf, wherein the sensor comprises a waveguide, and
wherein the sensor is capable of sensing both items containing metal and items containing no metal;
a communications network, wherein a portion of the communication network is wireless; and
a computer, wherein the computer receives information from the sensor through the communications network;
wherein the sensor sends a first electromagnetic wave signal through the waveguide a first instance, monitors the reflection of the first electromagnetic wave signal, and sends related information to the computer through the communications network, wherein the sensor sends a second electromagnetic wave signal through the waveguide a second instance, monitors the reflection of the second electromagnetic wave signal, and sends related information to the computer through the communications network, wherein the computer compares the information from the first instance and the second instance to determine changes in the quantity of items within the first amount of space and wherein the computer signals to a user whether the quantity of items in the first area of space is greater than or equal to a first quantity or less than the first quantity.

34. An item monitoring system, comprising:
a shelf;
a photovoltaic sensor attached to the shelf, wherein the photovoltaic sensor responds to changes in the amount of light in a first amount of space above the photovoltaic sensor, and wherein the photovoltaic sensor is capable of sensing both items containing metal and items containing no metal;
a communications network, wherein a portion of the communication network is wireless; and
a computer, wherein the computer receives information from the photovoltaic sensor through the communications network;
wherein the photovoltaic sensor responds to the amount of light in the first amount of space a first instance and sends related information to the computer through the communications network, wherein the photovoltaic sensor responds to the amount of light in first amount of space a second instance and sends related information to the computer through the communications network, wherein the computer compares the information from the first instance and the second instance to determine changes in the quantity of items within the first amount of space, and wherein the computer signals to a user whether the quantity of items in the first area of space is greater than or equal to a first quantity or less than the first quantity.

35. A method of monitoring items, comprising the steps of:
providing a sensor, wherein the sensor senses a plurality of items in a first amount of space associated with the sensor, wherein the sensor is capable of sensing both items containing metal and items containing no metal;
placing a plurality of items in the first amount of space;
sensing the plurality of items in the first amount of space a first instance with the sensor; and
determining the quantity of items within the first amount of space.

36. The method of claim 35 further comprising the steps of:
providing a surface, a communications network, and a computer, wherein the sensor is attached to the surface, and wherein the computer receives information from the sensor through the communications network;
after the sensing step, sending information related to the sensing step to the computer through the communications network; and
determining the quantity of items within the first amount of space with the computer.

37. The method of claim 36 further comprising the steps of:
sensing the plurality of items in the first amount of space a second instance and sending related information to the computer through the communications network; and
wherein the determining step includes comparing the information from the first instance and the second instance to determine changes in the quantity of items within the first amount of space.

38. The method of claim 37, wherein during the sensing step during the first instance, the first amount of space includes a first quantity of items, and wherein before the sensing step during the second instance, the first amount of space includes a second quantity of items, and wherein the method further comprises the step of calibrating the sensor based on the information from the sensing step during the first instance and the sensing step during the second instance.

39. The method of claim 37, wherein during the first instance, the first amount of space is full of items, and wherein before the sensing step during the second instance, all of the items are removed from the first amount of space, and wherein the method further includes the step of calibrating the sensor by interpolating the information from the sensing step during the first instance and the sensing step during the second instance to determine various quantities of items in the first amount of space.

40. The method of claim 35, wherein the sensor is independent of the weight of the items in the first amount of space.

41. The method of claim 36, wherein after the determining step, the computer signals to a user whether the quantity of items in the first area of space is greater than a first quantity or less than the first quantity.

42. The method of claim 36, wherein after the determining step, the computer signals to a user whether the quantity of items in the first area of space is greater than a first quantity, less than the first quantity and greater than a second quantity, or is less than a second quantity.

43. The method of claim 35, wherein the sensor is a planar capacitive sensor.

44. The method of claim 43, wherein the sensing step includes responding to changes in the electric field configuration in the first amount of space and producing a frequency change in the planar capacitive sensor.

45. The method of claim 44, wherein the method further comprises the steps of:
sensing the plurality of items in the first amount of space a second instance; and wherein the determining step includes comparing the frequency measurements from the first instance and the second instance to determine changes in the quantity of items within the first amount of space.

46. The method of claim 43, wherein the sensing step includes responding to changes in the electric field configuration in the first amount of space and producing a phase change in the planar capacitive sensor.

47. The method of claim 46, and wherein the method further comprises the step of:
sensing the plurality of items in the first amount of space a second instance; and wherein the determining step includes comparing the phase measurements from the first instance and the second instance to determine changes in the quantity of items within the first amount of space.

48. The method of claim 35, wherein the sensor comprises a waveguide.

49. The method of claim 48, wherein the sensing step includes sending a first signal through the waveguide.

50. The method of claim 49, wherein the method further comprises the step of:
sensing the plurality of items in the first amount of space a second instance by sending a second signal through the waveguide; and
wherein the determining step includes comparing the signal measurements from the first instance and the second instance to determine changes in the quantity of items within the first amount of space.

51. The method of claim 35, wherein the sensor comprises a photosensitive sensor.

52. The method of claim 51, wherein the sensing step includes the photosensitive sensor responding to changes in the amount of light in the first amount of space.

53. The method of claim 52, after the placing step, removing one of the plurality of items from the first amount of space, and wherein the sensing step includes producing a current, voltage or resistance change in the photosensitive sensor.

54. The method of claim 52, wherein the method further comprises the step of:
sensing the plurality of items in the first amount of space a second instance by the photosensitive sensor responding to the amount of light in the first amount of space a second instance; and
wherein the determining step includes comparing the measurements from the first instance and the second instance to determine changes in the quantity of items within the first amount of space.

55. The method of claim 51, wherein the sensor is a photovoltaic sensor.

56. The method of claim 35, wherein the plurality of items within the first amount of space are all the same stock keeping unit.

57. The method of claim 35, wherein the plurality of items within the first amount of space are a plurality of different stock keeping units.

58. A capacitive sensor for monitoring items, comprising:
a planar capacitive sensor that senses a plurality of items in a first amount of space associated with the planar capacitive sensor, wherein the capacitive sensor responds to changes in the electric field configuration in the first amount of space associated with the planar capacitive sensor by producing a frequency change to determine the quantity of items in the first amount of space, and wherein the planar capacitive sensor is capable of sensing both items containing metal and items containing no metal.

59. The capacitive sensor of claim 58, wherein the planar capacitive sensor measures the frequency a first instance, wherein the planar capacitive sensor measures the frequency a second instance, and wherein the planar capacitive sensor compares the frequency from the first instance and the second instance to determine changes in the quantity of items within the first amount of space.

60. The capacitive sensor of claim 58, wherein the planar capacitive sensor is connected to a computer, and wherein the planar capacitive sensor measures the frequency a first instance and sends related information to the computer, wherein the planar capacitive sensor measures the frequency a second instance and sends related information to the computer, and wherein the computer compares the frequency from the first instance and the second instance to determine changes in the quantity of items within the first amount of space.

61. The capacitive sensor of claim 60, wherein the computer signals to a user whether the quantity of items in the first area of space is greater than or equal to a first quantity or less than the first quantity.

62. The capacitive sensor of claim 58, wherein the capacitive sensor includes electrodes attached to a non-metal substrate, wherein the electrodes comprise patterned conductors.

63. A capacitive sensor for monitoring items, comprising:
a planar capacitive sensor that senses a plurality of items in a first amount of space associated with the planar capacitive sensor, wherein the capacitive sensor responds to changes in the electric field configuration in the first amount of space by producing a phase change to determine the quantity of items in the first amount of space, wherein the planar capacitive sensor is capable of sensing both items containing metal and items containing no metal.

64. The capacitive sensor of claim 63, wherein the planar capacitive sensor measures the phase a first instance, wherein the planar capacitive sensor measures the phase a second instance, wherein the planar capacitive sensor compares the phase from the first instance and the second instance to determine changes in the quantity of items within the first amount of space.

65. The capacitive sensor of claim 64, wherein the planar capacitive sensor is connected to a computer, wherein the planar capacitive sensor measures the phase a first instance and sends related information to the computer, wherein the planar capacitive sensor measures the phase a second instance and sends related information to the computer, and wherein the computer compares the phase from the first instance and the second instance to determine changes in the quantity of items within the first amount of space.

66. The capacitive sensor of claim 65, wherein the computer signals to a user whether the quantity of items in the first area of space is greater than or equal to a first quantity or less than the first quantity.

67. The capacitive sensor of claim 58, wherein the capacitive sensor includes electrodes attached to a non-metal substrate, wherein the electrodes comprise patterned conductors.

68. A waveguide sensor for monitoring items, comprising:
a waveguide sensor including a waveguide that senses a plurality of items in a first amount of space associated with the waveguide sensor, wherein the waveguide sensor sends a signal through the waveguide and monitors the signal's reflection to determine the quantity of items in the first amount of space, wherein the sensor is capable of sensing both items containing metal and items containing no metal.

69. The waveguide sensor of claim 68, wherein the waveguide sensor sends a first signal through the waveguide a first instance and monitors the reflection of the first signal, wherein the waveguide sensor sends a second signal through the waveguide a second instance and monitors the reflection of the second signal, wherein the waveguide sensor compares the reflection of the first signal from the first instance and the reflection of the second signal the second instance to determine changes in the quantity of items within the first amount of space.

70. The waveguide sensor of claim 68, wherein the waveguide sensor is connected to a computer, wherein the waveguide sensor sends a first signal through the waveguide a first instance, monitors the reflection of the first electromagnetic wave signal, and sends related information to the computer, wherein the waveguide sensor sends a second signal through the waveguide a second instance, monitors the reflection of the second signal, and sends related information to the computer, wherein the computer compares the information from the first instance and the second instance to determine changes in the quantity of items within the first amount of space.

71. The waveguide sensor of claim 70, wherein the computer signals to a user whether the quantity of items in the first area of space is greater than or equal to a first quantity or less than the first quantity.

72. A photosensitive sensor for monitoring items, comprising:
a photosensitive sensor that senses a plurality of items in a first amount of space associated with the photosensitive sensor, wherein the photosensitive sensor responds to changes in the amount of light in a first amount of space, and wherein the photosensitive sensor is capable of sensing both items containing metal and items containing no metal.

73. The photosensitive sensor of claim 72, wherein the photosensitive sensor responds to the amount of light in the first amount of space a first instance, wherein the photosensitive sensor responds to the amount of light in first amount of space a second instance, wherein the photosensitive sensor compares the information from the first instance and the second instance to determine changes in the quantity of items within the first amount of space.

74. The photosensitive sensor of claim 73, wherein the photosensitive sensor is connected to a computer, wherein the photosensitive sensor responds to the amount of light in the first amount of space a first instance and sends related information to the computer, wherein the photosensitive sensor responds to the amount of light in first amount of space a second instance and sends related information to the computer, wherein the computer compares the information from the first instance and the second instance to determine changes in the quantity of items within the first amount of space.

75. The photosensitive sensor of claim 74, wherein the computer signals to a user whether the quantity of items in the first area of space is greater than or equal to a first quantity or below the first quantity.

76. The photosensitive sensor of claim 72, wherein the photosensitive sensor is photovoltaic sensor.
